(19) United States
(12) Patent Application Publication
(10) Pub. No.: US 2019/0358821 A1
(43) Pub. Date: Nov. 28, 2019

(54) WALKING TRAINING ROBOT

(71) Applicant: Panasonic Corporation, Osaka (JP)

(72) Inventors: Kazunori YAMADA, Aichi (JP); Mayu WATABE, Tokyo (JP)

(21) Appl. No.: 16/401,770

(22) Filed: May 2, 2019

(30) Foreign Application Priority Data
May 25, 2018 (JP) 2018-100619
Jan. 16, 2019 (JP) 2019-005498

(51) Int. Cl. B25J 11/00; B25J 9/16; A61H 3/04; B25J 5/00; B25J 13/02; B25J 13/08

(52) U.S. Cl. CPC B25J 11/009; B25J 9/1674; A61H 3/04; B25J 13/085; B25J 5/007; B25J 13/02; B25J 13/081; B25J 9/1612

(57) ABSTRACT

A walking training robot according to the present disclosure includes: a main body part; a handle part disposed on the main body part for being griped by the user; a detecting part detecting a handle load applied to the handle part; a walking supporting part determining a load applied by the walking training robot to a walking exercise of the user based on the detected handle load; a moving device including a rotating body and controlling the rotating body to move the walking training robot based on the determined load of the walking training robot; a posture estimating part estimating a foot-lifting posture of the user based on the detected handle load; a training scenario generating part correcting a training scenario causing the user to perform a foot-lifting exercise, based on the foot-lifting posture; and a presenting part presenting an instruction to the user based on the training scenario.

### CROSS REFERENCE TO RELATED APPLICATIONS

The present application claims priority to Japanese Patent Application No. 2018-100619 filed May 25, 2018 and Japanese Patent Application No. 2019-005498 filed Jan. 16, 2019, the entire contents of each of which are incorporated herein by reference.

### BACKGROUND OF THE INVENTION

### 1. Field of the invention

The present disclosure relates to a walking training robot improving a physical ability of a user.

### 2. Description of the Related Art

Various training systems are used in facilities for the elderly to improve the physical ability of the elderly (see, e.g., Japanese Laid-Open Patent Publication No. 2002-263152).

Japanese Laid-Open Patent Publication No. 2002-263152 discloses a walker enabling a placed load measurement and a foot action measurement for recognition of a current state of walking and capable of providing a walking training while confirming a degree of recovery of the lower half of the body.

A walking training robot capable of efficiently improving a physical ability of a user is recently required.

### SUMMARY OF THE INVENTION

The present disclosure solves the problem and provides a walking training robot capable of efficiently improving a physical ability of a user.

A walking training robot according to an aspect of the present disclosure is
a walking training robot improving a physical ability of a user, comprising:
a main body part;
a handle part disposed on the main body part for being griped by the user;
a detecting part detecting a handle load applied to the handle part;
a walking supporting part determining a load applied by the walking training robot to a walking exercise of the user based on the handle load detected by the detecting part;
a moving device including a rotating body and controlling the rotating body to move the walking training robot based on the load of the walking training robot determined by the walking supporting part;
a posture estimating part estimating a foot-lifting posture of the user based on the handle load detected by the detecting part;
a training scenario generating part correcting a training scenario causing the user to perform a foot-lifting exercise, based on the foot-lifting posture; and
a presenting part presenting an instruction to the user based on the training scenario.

The walking training robot of the present disclosure can efficiently improve a physical ability of a user.

### BRIEF DESCRIPTION OF THE DRAWINGS

FIG. 1 is an external view of a walking training robot according to a first embodiment of the present disclosure;

FIG. 2 is a diagram showing how a training is performed by using the walking training robot according to the first embodiment of the present disclosure;

FIG. 3 is a diagram showing a detection direction of a handle load detected by a detecting part in the first embodiment of the present disclosure;

FIG. 4 is a control block diagram showing an example of a control configuration of the walking training robot according to the first embodiment of the present disclosure;

FIG. 5 is a control block diagram showing an example of a main control configuration of the walking training robot according to the first embodiment of the present disclosure;

FIG. 6 is a diagram showing an example of a state in which a user lifts the right foot while gripping a handle part;

FIG. 7 is a diagram showing an example of a relationship between a handle load and a foot-lifting posture;

FIG. 8A is a diagram showing an example of a walking route;

FIG. 8B is a diagram showing another example of a walking route;

FIG. 9 is a diagram showing an exemplary flowchart of a main control of the walking training robot according to the first embodiment of the present disclosure;

FIG. 10 is a diagram showing an exemplary flowchart of a control for correcting a walking training scenario based on a gymnastic training result in the walking training robot according to the first embodiment of the present disclosure;

FIG. 11 is a diagram showing an exemplary flowchart of a control for correcting a gymnastic training scenario based on a gymnastic training result in the walking training robot according to the first embodiment of the present disclosure;

FIG. 12 is a diagram showing an exemplary flowchart of a control for correcting the gymnastic training scenario and the walking training scenario based on a walking training result in the walking training robot according to the first embodiment of the present disclosure;

FIG. 13 is a diagram showing an exemplary flowchart of a control for correcting the gymnastic training scenario and the walking training scenario based on the gymnastic training result and the walking training result in the walking training robot according to the first embodiment of the present disclosure;

FIG. 14 is a control block diagram showing an example of a main control configuration of a modification of the walking training robot according to the first embodiment of the present disclosure;

FIG. 15 is a control block diagram showing an example of a control configuration of a walking training robot according to a second embodiment of the present disclosure;

FIG. 16 is a control block diagram showing an example of a main control configuration of the walking training robot according to the second embodiment of the present disclosure; and

FIG. 17 is a diagram showing an exemplary flowchart of a control for correcting the walking training scenario based on a gymnastic training result, a walking training result, complexity of a walking route, and left-right imbalance of foot lifting in the walking training robot according to the second embodiment of the present disclosure.

### DESCRIPTION OF THE PREFERRED EMBODIMENTS

### (Background of the Present Disclosure)

In recent years, as the birthrate declines and the aging population grows in developed countries, the need for watching and supporting the living of the elderly is increasing. Particularly, QOL (Quality of Life) of daily life tends to be difficult for the elderly to maintain due to a decline in physical ability with aging. Under such circumstances, a walking training robot capable of efficiently improving a physical ability of a user such as the elderly is required.

The present inventors found in the process of research that performing a foot-lifting exercise in connection with walking can prevent falling and efficiently improve a physical ability related to walking. The present inventors therefore conducted a study on a walking training robot causing a user to consciously perform a foot-lifting exercise. Specifically, the present inventors conducted a study on a walking training robot capable of providing a gymnastic training in which a user performs a foot-lifting gymnastic exercise in a standing state and a walking training in which a gait of a user during walking is changed.

The present inventors also found that a foot-lifting posture of a user can be estimated based on a handle load applied to a handle part. The present inventors therefore conducted a study on a walking training robot capable of correcting training contents from a foot-lifting posture estimated based on the handle load, thereby completing the following invention.

A walking training robot, according to an aspect of the present disclosure is
a walking training robot improving a physical ability of a user, comprising:
a main body part;
a handle part disposed on the main body part for being griped by the user;
a detecting part detecting a handle load applied to the handle part;
a walking supporting part determining a load applied by the walking training robot to a walking exercise of the user based on the handle load detected by the detecting part;
a moving device including a rotating body and controlling the rotating body to move the walking training robot based on the load of the walking training robot determined by the walking supporting part;
a posture estimating part estimating a foot-lifting posture of the user based on the handle load detected by the detecting part;
a training scenario generating part correcting a training scenario causing the user to perform a foot-lifting exercise, based on the foot-lifting posture; and
a presenting part presenting an instruction to the user based on the training scenario.

With such a configuration, the physical ability of the user can efficiently be improved.

The load may be a movement speed and a movement direction of the walking training robot.

With such a configuration, the physical ability of the user can more efficiently be improved.

The load may be a force required for pushing the walking training robot in a movement direction of the user.

With such a configuration, the physical ability of the user can more efficiently be improved.

The walking training robot may include a walking state estimating part estimating a walking speed and a walking direction of the user, and
the walking supporting part may determine the load of the walking training robot based on the walking speed and the walking direction of the user estimated by the walking state estimating part.

With such a configuration, the physical ability of the user can more efficiently be improved.

The posture estimating part may include a gymnastic posture estimating part estimating a gymnastic posture that is the foot-lifting posture when the user is performing a foot-lifting gymnastic exercise in a standing state, based on the handle load detected by the detecting part,
the training scenario generating part may include a walking training scenario generating part generating a walking training scenario that is the training scenario in which a gait of the user during walking is changed, and
the walking training scenario generating part may correct the walking training scenario based on the gymnastic posture.

With such a configuration, the walking training scenario can be corrected based on the gymnastic posture, so that a walking training more suitable for the user can be provided. As a result, the physical ability of the user can more efficiently be improved.

The training scenario generating part may include a gymnastic training scenario generating part generating a gymnastic training scenario that is the training scenario in which the user performs the foot-lifting gymnastic exercise in a standing state, and
the gymnastic training scenario generating part may correct the gymnastic training scenario based on the gymnastic posture.

With such a configuration, the gymnastic training scenario can be corrected based on the gymnastic posture, so that a gymnastic training more suitable for the user can be provided. As a result, the physical ability of the user can more efficiently be improved.

The walking supporting part may correct the load of the walking training robot based on the walking training scenario.

With such a configuration, by correcting the load of the walking training robot, the gait of the user during walking can be changed. As a result, the physical ability of the user can more efficiently be improved.

The gymnastic posture estimating part may estimate the gymnastic posture based on an axial, moment around an axis extending in a front-rear direction of the walking training robot, and
the gymnastic posture may include at least one of a foot-lifting amount, a time of lifting of a foot, and a fluctuation when the user is performing the foot-lifting gymnastic exercise.

With such a configuration, the gymnastic posture of the user can easily be estimated.

The walking training scenario may include at least one of a guidance through a walking route from a current location to a destination of the user while the user is walking and a foot-lifting instruction.

With such a configuration, a walking training more suitable for the user can be provided to the user, so that the physical ability of the user can more efficiently be improved.

The posture estimating part may include a walking posture estimating part estimating a walking posture that is the foot-lifting posture when the user is walking, based on the handle load detected by the detecting part,
the training scenario generating part may include a gymnastic training scenario generating part generating a gymnastic training scenario that is the training scenario in which the user performs the foot-lifting gymnastic exercise in a standing state, and
the gymnastic training scenario generating part may correct the gymnastic training scenario based on the walking posture.

With such a configuration, the gymnastic training scenario can be corrected based on the walking posture, so that a gymnastic training more suitable for the user can be provided. As a result, the physical ability of the user can more efficiently be improved.

The training scenario generating part may include a walking training scenario generating part generating a walking training scenario that is the training scenario in which a gait of the user during walking is changed, and
the walking training scenario generating part may correct the walking training scenario based on the walking posture.

With such a configuration, the walking training scenario can be corrected based on the walking posture, so that a walking training more suitable for the user can be provided. As a result, the physical ability of the user can more efficiently be improved.

The walking supporting part may correct a movement speed and a movement direction of the walking training robot based on the walking training scenario.

With such a configuration, by correcting the movement speed and the movement direction of the walking training robot, the gait of the user during walking can be changed. As a result, the physical ability of the user can more efficiently be improved.

The walking posture estimating part may estimate the walking posture based on an axial moment around an axis extending in a front-rear direction of the walking training robot, and
the walking posture may include at least one of a foot-lifting amount, a time of lifting of a foot, a fluctuation, a stride, a walking speed, and a walking pitch when the user is walking.

With such a configuration, the walking posture of the user can easily be estimated.

The gymnastic training scenario may include at least, one of a foot-lifting amount and the number of times of foot lifting when the user performs a foot-lifting gymnastic exercise.

With such a configuration, a gymnastic training more suitable for the user can be provided to the user, so that the physical ability of the user can more efficiently be improved.

The posture estimating part may include
a gymnastic posture estimating part estimating a gymnastic posture that is the foot-lifting posture when the user is performing a foot-lifting gymnastic exercise in a standing state, based on the handle load detected by the detecting part, and
a walking posture estimating part estimating a walking posture that is the foot-lifting posture when the user is walking, based on the handle load detected by the detecting part.
the training scenario generating part may include a walking training scenario generating part generating a walking training scenario that is the training scenario in which a gait of the user during walking is changed, and
the walking training scenario generating part may correct the walking training scenario based on the gymnastic posture and the walking posture.

With such a configuration, the walking training scenario can be corrected based on the gymnastic posture and the walking posture, so that a walking training more suitable for the user can be provided. As a result, the physical ability of the user can more efficiently be improved.

The posture estimating part may include
a gymnastic posture estimating part estimating a gymnastic posture that is the foot-lifting posture when the user is performing a. foot-lifting gymnastic exercise in a standing state, based on the handle load detected by the detecting part, and
a walking posture estimating part estimating a walking posture that is the foot-lifting posture when the user is walking, based on the handle load detected by the detecting part,
the training scenario generating part may include a gymnastic training scenario generating part generating a gymnastic training scenario that is the training scenario in which the user performs the foot-lifting gymnastic exercise in a standing state, and
the gymnastic training scenario generating part may correct the gymnastic training scenario based on the gymnastic posture and the walking posture.

With such a configuration, the gymnastic training scenario can be corrected based on the gymnastic posture and the walking posture, so that a gymnastic training more suitable for the user can be provided. As a result, the physical ability of the user can more efficiently be improved.

The walking training robot may further comprise a determining part determining a complexity of a walking route that the user has walked, based on a rotation amount and a rotation direction of the rotating body,
the training scenario generating part may correct the training scenario based on the complexity of the walking route.

With such a configuration, the training scenario can be corrected based on the complexity of the walking route. As a result, the physical ability of the user can more efficiently be improved.

The determining part may further determine a left-right imbalance of foot lifting of the user based on the handle load detected by the detecting part, and
the training scenario generating part may correct the training scenario based on the left-right imbalance of foot lifting.

With such a configuration, the training scenario can be corrected based on the left-right imbalance of foot lifting of the user, a training more suitable for the user can be provided. As a result, the physical ability of the user can more efficiently be improved.

The presenting part may present an instruction to the user based on the training scenario through light in a surrounding environment.

With such a configuration, the user can easily understand. and perform a training in accordance with, the instruction based on the training scenario.

The presenting part may present information of the foot-lifting posture of the user.

With such a configuration, the user can perform training while comprehending the his/her own foot-lifting posture.

Embodiments of the present disclosure will now be described with reference to the accompanying drawings. In the figures, elements are shown in an exaggerated manner for facilitating description,

### FIRST EMBODIMENT

### [Overall Configuration]

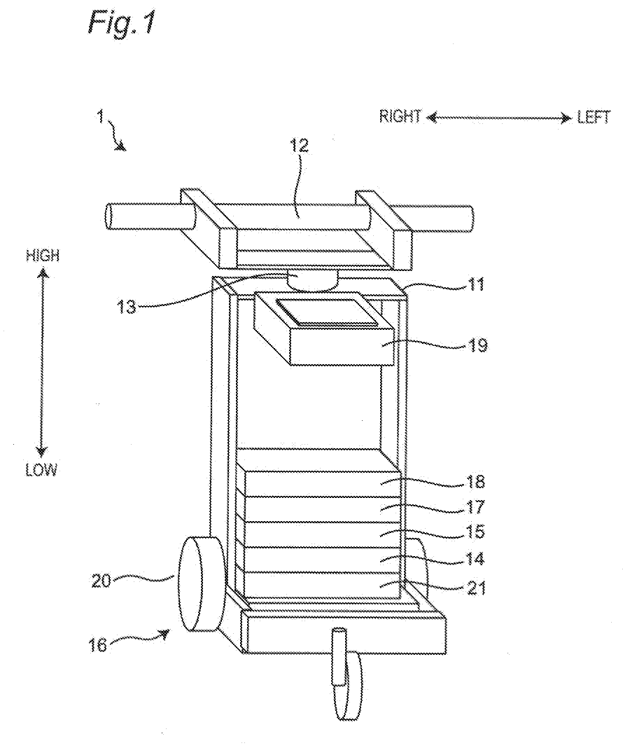

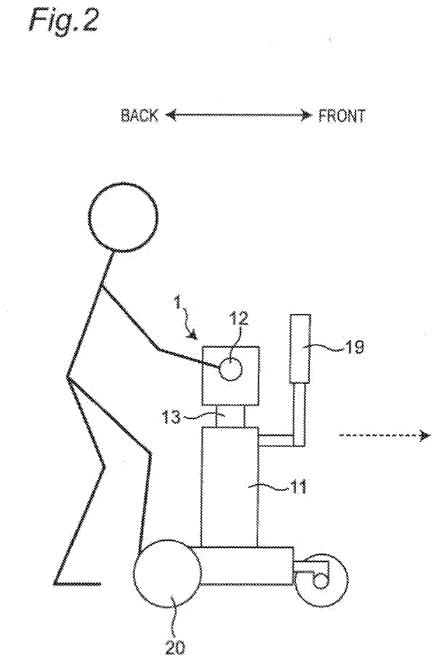

FIG. 1 shows an external view of a walking training robot 1 (hereinafter referred to as “robot 1”) according to a first embodiment. FIG. 2 shows how a user performs a training with the robot 1.

As shown in FIGS. 1 and 2, the robot 1 includes a main body part 11, a handle part 12, a detecting part 13, a walking state estimating part 14, a walking supporting part 15, a moving device 16, a posture estimating part 17, a training scenario generating part 18, and a presenting part 19.

The robot 1 is a robot providing a training for improving a physical ability of a user. The robot 1 can provide a gymnastic training in which a user performs a foot-lifting gymnastic exercise in a standing state and a walking training in which a gait of a user during walking is changed. The foot-lifting gymnastic exercise means an exercise in which a user lifts and lowers his/her foot without moving. In other words, the foot-lifting gymnastic exercise means an exercise in which a user lifts his/her foot from the ground and then puts the foot down onto the ground again. For example, the foot-lifting gymnastic exercise may be an exercise of alternately moving the left and right feet of the user up and down, or an exercise of continuously moving one foot up and down. The gait means a motion of moving the feet from the back to the front.

In the gymnastic training, the user grips the handle part 12 and performs the foot-lifting gymnastic exercise without moving on the spot. For example, the robot 1 causes the presenting part 19 to present a foot-lifting instruction, a number of times of foot lifting, and/or an amount of foot lifting to the user. The lifting instruction includes, for example, an instruction causing the user to lift one of the left and right feet etc.

In the walking training, the user grips the handle part 12 and walks while applying a load (handle load) to the handle part 12. The robot 1 moves in accordance with the handle load and guides the user to a walking route. Additionally, the robot 1 changes the gait of the user during walking. For example, the robot 1 changes the gait of the user during walking by limiting a movement speed of the robot 1 and/or changing the walking route. In this description, the walking route means a route of the user walking from a current location to a destination.

A configuration of the robot 1 will hereinafter be described in detail.

The main body part 11 is made up of a frame having a rigidity capable of supporting other constituent members and supporting a load when the user walks, for example.

The handle part 12 is disposed on an upper portion of the main body part 11 and is disposed in a shape and at a height position facilitating the user gripping the handle part with both hands during walking. In the first embodiment, the handle part 12 is formed in a rod shape. The user grips the right end side of the handle part 12 with the right hand and grips the left end side of the handle part 12 with the left hand.

The detecting part 13 detects the handle load applied to the handle part 12 by the user when the user grips the handle part 12. Specifically, when the user grips the handle part 12 and walks, and when the user grips the handle part 12 and performs the foot-lifting gymnastic exercise in a standing state, the user applies a load to the handle part 12. The detecting part 13 detects a direction and a magnitude of the load (handle load) applied to the handle part 12 by the user.

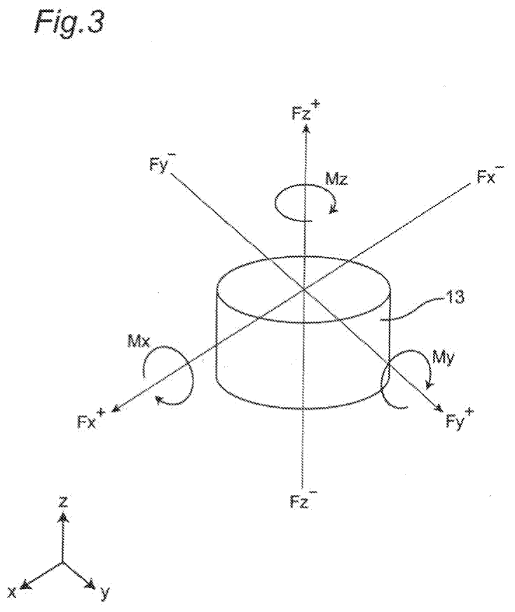

FIG. 3 shows a detection direction of the handle load detected by the detecting part 13. As shown in FIG. 3, the detecting part 13 is a hexaxial force sensor capable of detecting each of forces applied in directions of three axes orthogonal to each other and axial moments around the three axes. The three axes orthogonal to each other are an x axis extending in a left-right direction of the robot 1, ay axis extending in a front-rear direction of the robot 1, and a z axis extending in a height direction of the robot 1. The forces applied in the directions of three axes are a force Fx applied in an x-axis direction, a force Fy applied in a y-axis direction, and a force Fz applied in a z-axis direction. In the first embodiment, regarding Fx, the force applied in the right direction of is denoted by Fx⁺ and the force applied in the left direction is denoted by Fx⁻. Regarding Fy, the force applied in the forward direction is denoted by Fy⁺ and the force applied in the backward direction is denoted by Fy⁻. Regarding directions of Fz, the force applied in the vertical upward direction with respect to a walking surface is denoted by Fz⁺ and the force applied in the vertical downward direction with respect to a walking surface is denoted by Fz⁻. The axial moments around the three axes are an axial moment Mx around the x axis, an axial moment My around the y axis, and an axial moment Mz around the z axis. In this description, Fx, Fy, Fz, Mx, My, and Mz may be referred to as a load.

Returning to FIGS. 1 and 2, the walking state estimating part 14 estimates a walking speed and a walking direction of a walking user based on the handle load detected by the detecting part 13. The walking speed means the speed of the user when the user is walking. The walking direction means the direction in which the user walks. The walking state estimating part 14 estimates the walking speed and the walking direction of the walking user based on the magnitude and direction of the handle load (forces and moments) detected by the detecting part 13.

Specifically, the walking state estimating part 14 estimates the walking speed and the walking direction of the walking user from a value of the handle load in each movement direction detected by the detecting part 13. For example, the walking state estimating part 14 estimates a forward motion, a backward motion, a right turning motion, and a left turning motion based on the handle load.

### <Forward Motion>

When the force of Fy⁺ is detected by the detecting part 13, the walking state estimating part 14 estimates that the user is moving in the forward direction. In other words, when the force of Fy⁺ is detected by the detecting part 13, the walking state estimating part 14 estimates that the user is performing the forward motion. When the force of Fy⁺ detected by the detecting part 13 becomes larger while the user is performing the forward motion, the walking state estimating part 14 estimates that the walking speed of the user in the forward direction is increasing. On the other hand, When the force of Fy⁺ detected by the detecting part 13 becomes smaller while the user is performing the forward motion, the walking state estimating part 14 estimates that the walking speed of the user in the forward direction is decreasing.

### <Backward Motion>

When the force of Fy⁻is detected by the detecting part 13, the walking state estimating part 14 estimates that the user is moving in the backward direction. In other words, when the force of Fy⁻ is detected by the detecting part 13, the walking state estimating part 14 estimates that the user is performing the backward motion. When the force of Fy⁻ detected by the detecting part 13 becomes larger while the user is performing the backward motion, the walking state estimating part 14 estimates that the walking speed of the user in the backward direction is increasing. On the other hand, When the force of Fy⁻ detected by the detecting part 13 becomes smaller while the user is performing the backward motion, the walking state estimating part 14 estimates that the walking speed of the user in the backward direction is decreasing.

### <Right Turning Motion>

When the force of Fy⁺ and the moment of Mz⁺ are detected by the detecting part 13, the walking state estimating part 14 estimates that the user is turning and moving to the right. In other words, when the force of Fy⁺ and the moment of Mz⁺ are detected by the detecting part 13, the walking state estimating part 14 estimates that the user is performing the right turning motion. When the moment of Mz⁺ detected by the detecting part 13 becomes larger while the user is performing the right turning motion, the walking state estimating part 14 estimates that the right turning radius of the user is decreasing. When the force of Fy⁺ detected by the detecting part 13 becomes larger while the user is performing the right turning motion, the walking state estimating part 14 estimates that the turning speed is increasing.

### <Left Turning Motion>

When the force of Fy⁺ and the moment of Mz are detected by the detecting part 13, the walking state estimating part 14 estimates that the user is turning and moving to the left. In other words, when the force of Fy⁺ and the moment of Mz⁻ are detected by the detecting part 13, the walking state estimating part 14 estimates that the user is performing the left turning motion. When the moment of Mz⁻ detected by the detecting part 13 becomes larger while the user is performing the left turning motion, the walking state estimating part 14 estimates that the turning radius of the user is decreasing. When the force of Fy⁺ detected by the detecting part 13 becomes larger while the user is performing the left turning motion, the walking state estimating part 14 estimates that the turning speed is increasing.

The walking state estimating part 14 may estimate the walking speed and the walking direction of the user based on the handle load and is not 1 limited to the example described above. For example, the walking state estimating part 14 may estimate the forward motion and the backward motion of the user based on the forces of Fy and Fz. The walking state estimating part 14 may estimate the turning motion of the user based on the moments of Mx or My, for example.

For example, when the force of Fy⁺ detected by the detecting part 13 has a value equal to or greater than a predetermined first threshold value and the force of My⁺ has a value less than a predetermined second threshold value, the walking state estimating part 14 estimates that the user is walking in the forward direction, i.e., performing the forward motion. The walking state estimating part 14 may estimate the walking speed based on a value of the handle load in the Fz direction. On the other hand, when the force of Fy⁺ detected by the detecting part 13 has a value equal to or greater than a predetermined third threshold value and the force of My⁺ has a value equal to or greater than the predetermined second threshold value, the walking state estimating part 14 may estimate that the user is walking while turning to the right, i.e., performing the right turning motion. The walking state estimating part 14 may estimate the turning speed based on a value of the handle load in the Fz direction and estimate the turning radius based on a value of the handle load in the My direction.

The handle load used for estimating the walking speed may be the load of Fy⁺ in the forward direction or the load of Fz⁻ in the downward direction, or a combination of the load of Fy⁺ in the forward direction and the load of Fz⁻ in the downward direction.

Based on the handle load detected by the detecting part 13, the walking supporting part 15 determines a load applied by the robot 1 to a walking exercise of the user. In the first embodiment, the walking supporting part 15 determines a movement speed and a movement direction of the robot 1 as a load of the robot 1 based on the walking speed and the walking direction of the user estimated by the walking state estimating part 14. For example, the walking supporting part 15 may determine the movement speed and the movement direction of the robot 1 made equal to the walking speed and the walking direction of the user. Alternatively, the walking supporting part 15 may determine the movement speed and the movement direction of the robot 1 made slower than the walking speed and walking direction of the user.

The walking supporting part 15 may change the gait of the user during walking by correcting the movement speed and the movement direction of the robot 1. Specifically, the walking supporting part 15 may correct the movement speed and the movement direction of the robot 1 based on a training scenario generated and/or corrected by the training scenario generating part 18. For example, the walking supporting part 15 may make the movement speed of the robot 1 slower than the walking speed of the user. Alternatively, the walking supporting part 15 may correct the movement direction to increase the turning radius when the user performs the turning motion.

The walking supporting part 15 may determine the movement speed and the movement direction of the robot 1 based on the walking speed and the walking direction of the user and/or information of the training scenario generated by the training scenario generating part 18 and is not limited to the example described above.

The moving device 16 includes a rotating body 20 disposed on a lower portion of the main body part 11, and a driving part 21 proving a drive control of the rotating body 20. The moving device 16 controls the rotating body 20 to move the robot 1 based on the movement speed and the movement direction of the robot 1 determined by the walking supporting part 15.

The rotating body 20 is a wheel supporting the main body part 11 in a self-standing state and rotationally driven by the driving part 21. In the first embodiment, the moving device 16 includes three rotating bodies 20. Specifically, the moving device 16 includes the two rotating bodies 20 oppositely disposed on the rear side of the robot 1 and the one rotating body 20 disposed on the front side of the robot 1. The two rotating bodies 20 disposed on the rear side of the robot 1 are rotated by the driving part 21 to move the robot 1. For example, the two rotating bodies 20 disposed on the rear side of the robot 1 move the main body part 11 in a direction of an arrow shown in FIG. 2 (in the forward direction or the backward direction) while maintaining the robot 1 in a self-standing posture. The one rotating body 20 disposed on the front side of the robot 1 is freely rotatable.

In the example described in the first embodiment, the moving device 16 includes three wheels as the rotating bodies 20; however, the present invention is not limited thereto. For example, the rotating bodies 20 may be made up of two or more wheels. Alternatively, the rotating body 20 may be a running belt, a roller, etc.

The driving part 21 drives the rotating bodies 20 based on the walking speed and the walking direction of the user determined by the walking supporting part 15.

The posture estimating part 17 estimates a foot-lifting posture of a user based on the handle load detected by the detecting part 13. The foot-lifting posture means a posture when the user is performing a motion of lifting the foot and means a posture of a foot-lifting exercise when the foot is lifted off the ground until being put onto the ground.

In the first embodiment, the posture estimating part 17 estimates the foot-lifting posture of the user based on the moment in the My direction detected by the detecting part 13.

The foot-lifting posture includes at least one of a foot height (foot-lifting amount) from the ground when the foot is lifted, a time of lifting of the foot off the ground until being put onto the ground (foot-lifting time), and a fluctuation. The fluctuation means user's unsteadiness during lifting of the foot.

The foot-lifting posture is not limited to the foot-lifting amount, the foot-lifting time, and the fluctuation. For example, the foot-lifting posture may include a stride, a walking speed, and a walking pitch.

The foot-lifting posture includes a gymnastic posture when the user is performing the foot-lifting gymnastic exercise in a standing state and a walking posture when the user is walking.

The gymnastic posture means a foot-lifting posture when the user is performing the foot-lifting gymnastic exercise without moving on the spot while gripping the handle part 12. The walking posture means a foot-lifting posture when the left and right feet of the walking user are alternately lifted and lowered. Therefore, the walking posture means a posture in a swing leg period when the user's foot is moved from the back to the front. The swing leg period means a period when the foot is off the ground.

The posture estimating part 17 estimates the foot-lifting posture for each of the left and right feet of the user.

The training scenario generating part 18 corrects the training scenario causing the user to perform the foot-lifting exercise based on the foot-lifting posture estimated by the posture estimating part 17. The training scenario is a scenario of a training to be performed by a user for improving the physical ability of the user. The training scenario may be, for example, a scenario for causing the user to perform an exercise for training the muscle of the right leg, an exercise for training the muscle of the left leg, and/or an exercise for training the muscles of both legs.

The training scenario includes a gymnastic training scenario in which the user performs the foot-lifting gymnastic exercise in a standing state and a walking training scenario in which the gait of the user during walking is changed.

The gymnastic training scenario is a scenario at the time of performing the gymnastic training and includes a scenario in which the user performs the foot-lifting gymnastic exercise in a standing state on the spot. The gymnastic training scenario may include, for example, an exercise of lifting one foot, a twisting exercise performed in accordance with rotation of the robot 1, and a twisting motion performed with one foot lifted.

In an example, the gymnastic training scenario may include a scenario including the foot-lifting gymnastic exercise with the number of times of foot lifting of the right foot set to 30 times and the number of times of foot lifting of the left foot set to 10 times, so as to preferentially train the muscle of the right leg. Alternatively, the gymnastic training scenario may include a scenario including the foot-lifting gymnastic exercise with the time of lifting of the right foot set to 30 seconds and the time of lifting of the left foot set to 10 seconds.

The walking training scenario is a scenario at the time of performing the walking training and includes a scenario in which the gait of the user during walking is changed. For example, the walking training scenario may include a scenario for instructing the user to lift the foot while limiting the movement speed of the robot 1. Alternatively, the walking training scenario may include a scenario for guiding the user through a walking route increased in frequency of use of the muscle of the leg to be trained. The walking route increased in frequency of use of the muscle of the leg to be trained may be, for example, a route including a larger number of motions of turning to the side opposite to the leg to be trained, and/or a route making a turning radius larger. For example, when it is desired to train the muscle of the right leg, the walking route may include a larger number of comers turning to the left than the right. Alternatively, the walking route may be such a route as to make the turning radius larger in the left turning motion.

The training scenario generating part 18 corrects the gymnastic training scenario and/or the walking training scenario based on information of the foot-lifting posture at the time of the gymnastic training and/or the foot-lifting posture at the time of the walking training. For example, the training scenario generating part 18 corrects the gymnastic training scenario and/or the walking training scenario based on a difference between the left and right foot-lifting postures at the time of the gymnastic training and/or walking training.

For example, when the foot-lifting amount of the right foot is smaller than the foot lifting amount of the left foot, the training scenario generating part 18 corrects the training scenario such that the muscle force of the right leg is used more than the left foot. In an example, the training scenario generating part 18 corrects the gymnastic training scenario such that the number of times of foot lifting of the right foot becomes larger than the number of times of foot lifting of the left foot. Alternatively, the training scenario generating part 18 corrects the walking training scenario such that the user is guided though a walking route having the turning radius of the left turns made larger while increasing the number of the left turning motions.

In this way, the training scenario generating part 18 corrects the training scenario based on the gymnastic training result and/or the walking training result.

A training scenario before correction may be, for example, a scenario including a predefined foot-lifting exercise or a scenario including an exercise customized for each user. The training scenario before correction means, for example, a scenario set at the start of training, or a scenario set by the user at the start of training.

The training scenarios described above are examples, and the training scenario is not limited to these examples.

The presenting part 19 presents an instruction to the user based on the training scenario. For example, the presenting part 19 presents an instruction to the user through a voice, an image, and/or a video. For example, the presenting part 19 may include a speaker and/or a display.

The robot 1 may have a self-position estimating part estimating the position of the robot 1 itself. The self-position estimating part is, for example, a GPS (Global Positioning System) and estimates the position where the robot 1 is located. This enables the robot 1 to estimate its own position, i.e., a current location, and to accurately guide the user through a walking route from the current location to a destination. Alternatively, self-position estimation may be performed by recognizing a surrounding environment with a camera or a depth sensor.

### [Control Structure of Walking Training Robot]

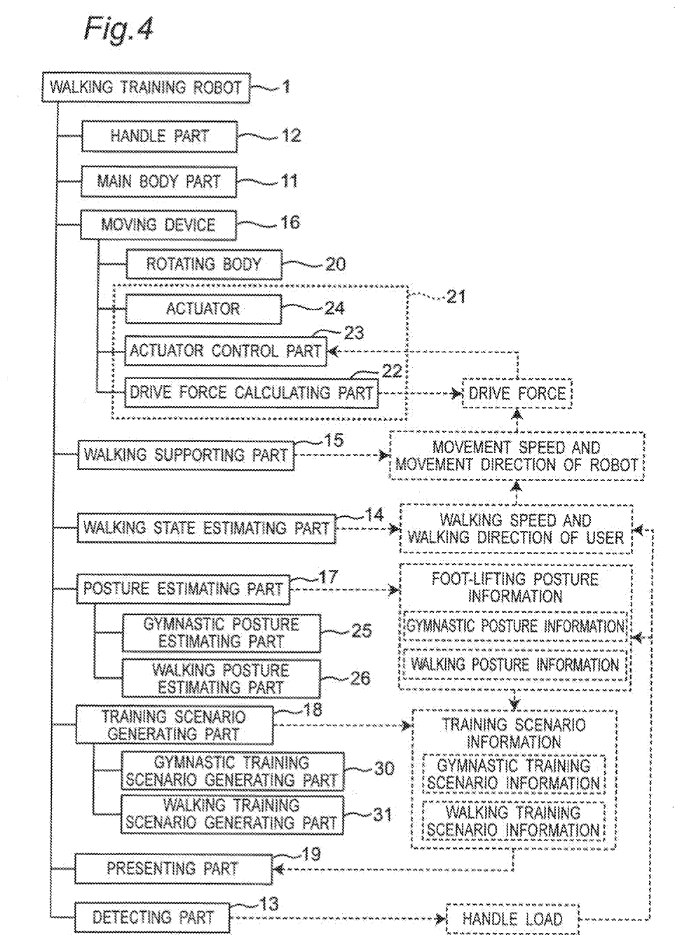

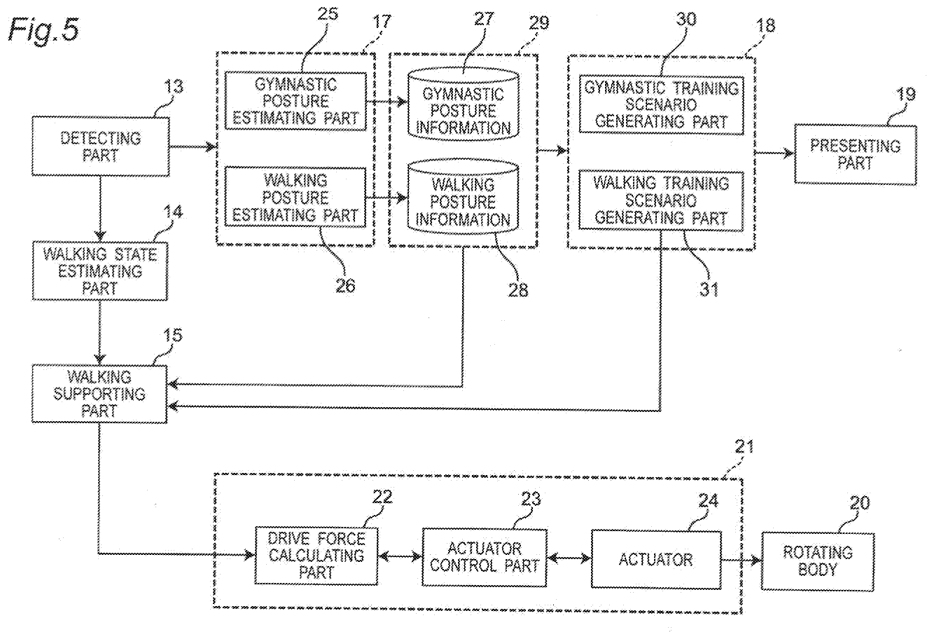

A control configuration of the walking training robot 1 having such a configuration will be described. FIG. 4 is a control block diagram showing an example of the control configuration of the robot 1. The control block diagram of FIG. 4 also shows a relationship between each element of the control configuration and information to be handled. FIG. 5 is a control block diagram showing an example of a main control configuration of the robot 1.

First, the control configuration for movement of the robot 1 will be described. As shown in FIGS. 4 and 5, the detecting part 13 detects the handle load applied to the handle part 12. The information of the handle load detected by the detecting part 13 is transmitted to the walking state estimating part 14.

The walking state estimating part 14 estimates the walking speed and the walking direction of the user based on the handle load detected by the detecting part 13. The walking state estimating part 14 transmits information of the estimated walking speed and walking direction of the user to the walking supporting part 15.

The walking supporting part 15 determines the movement speed and the movement direction of the robot 1 based on the walking speed and the walking direction of the user. The walking supporting part 15 transmits information of the determined movement speed and movement direction of the robot 1 to the driving part 21.

The driving force includes a drive force calculating part 22, an actuator control part 23, and an actuator 24.

The drive force calculating part 22 calculates a drive force based on the movement speed and the movement direction of the robot 1 determined by the walking supporting part 15. For example, when a moving motion of the robot 1 is the fox-ward motion or the backward motion, the drive force calculating part 22 calculates the drive force such that the rotation amounts of the two wheels (rotating bodies) 20 disposed on the rear side of the robot 1 become equal. when the moving motion of the robot 1 is the right turning motion, the drive force calculating part 22 calculates the drive force such that the rotation amount of the right wheel 20 becomes larger than the rotation of the left wheel 20 between the two wheels 20 disposed on the rear side of the robot 1. Additionally, the drive force calculating part 22 calculates a magnitude of the drive force in accordance with the movement speed of the robot 1.

The actuator control part 23 provides a drive control of the actuator 24 based on the drive force calculated by the drive force calculating part 22. The actuator control part 23 can acquire information of the rotation amounts of the wheels 20 from the actuator 24 and can transmit the information of the rotation amounts of the wheels 20 to the drive force calculating part 22.

The actuator 24 is a motor rotationally drives the wheels 20, for example. The actuator 24 is connected to the wheels 20 via a gear mechanism, a pulley mechanism, etc. The actuator 24 is subjected to the drive control by the actuator control part 23 to rotationally drive the wheels 20.

In this way, the robot 1 controls the movement based on the handle load applied to the handle part 12.

The control configuration for correcting the training contents of the robot 1 will be described.

The posture estimating part 17 estimates a foot-lifting posture of a user based on the handle load detected by the detecting part 13. In the first embodiment, the posture estimating part 17 estimates the foot-lifting posture of a user, i.e., the gymnastic posture and the walking posture, based on the moment of My of the handle load detected by the detecting part 13. The gymnastic posture and the walking posture may be determined based on the load of Fy or may be determined based on the rotation amount of the rotating bodies 20, for example.

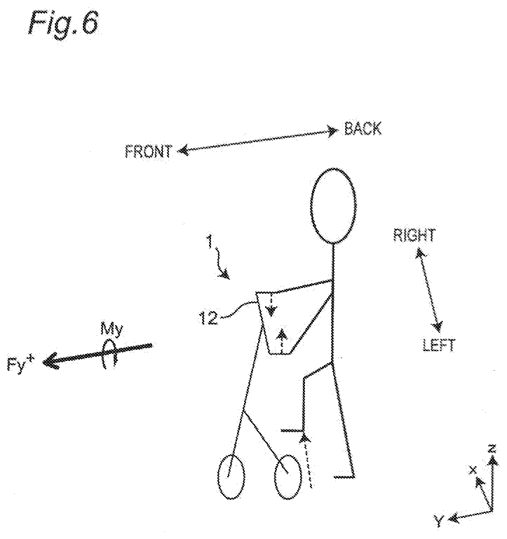

FIG. 6 is a diagram showing an example of a state in which the user lifts the right foot while gripping the handle part 12. As shown in FIG. 6, when the user lifts the right foot while gripping the handle part 12, a load is applied vertically downward to the right end of the handle part 12, and a load is applied vertically upward to the left, end of the handle part 12. Therefore, in the foot-lifting posture of the user lifting the right foot, the axial moment of My⁺ around the y axis extending in the front-rear direction of the robot 1 is generated in the handle part 12.

On the other hand, when the user lifts the left foot while gripping the handle part 12, a load is applied vertically downward to the left end off the handle part 12, and a load is applied vertically upward to the right end of the handle part 12. Therefore, in the foot-lifting posture of the user lifting the left foot, the axial moment of My⁺ around the y axis extending in the front-rear direction of the robot 1 is generated in the handle part 12.

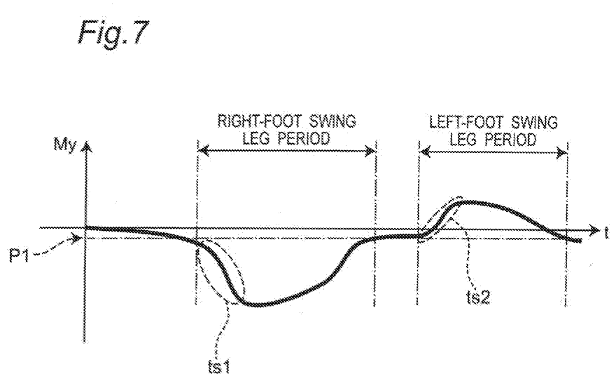

FIG. 7 is a diagram showing an example of a relationship between the handle load and the foot-lifting posture. FIG. 7 shows a waveform of the moment of My of the foot-lifting gymnastic exercise when the lifting of the right foot is followed by the lifting of the left foot.

As shown in FIG. 7, the moment of My⁻ occurs during a period when the user lifts the right foot, i.e., a right-foot swing leg period. The right-foot swing leg period is a period from when the right foot is lifted off the ground until being put onto the ground and corresponds to the foot-lifting time of the right foot. On the other hand, the moment of My⁺ occurs during a period when the user lifts the left foot., i.e., a left-foot swing leg period. The left-foot swing leg period is a period from when force left foot is lifted off the ground until being put onto the ground and corresponds to the foot-lifting time of the left foot.

The right-foot swing leg period and the left-foot swing leg period can be calculated from changes in value of the moment of My. Specifically, the foot-lifting time of the right foot and the foot-lifting time of the left, foot can be calculated from changes in value of the moment of My.

An example of calculation of the right-foot swing leg period will be described. The posture estimating part 17 calculates a moment P1 of My in a state (hereinafter referred to as “steady state”) in which the user grips the handle part 12 with both legs placed on the ground. The steady-state moment P1 of My may be different for each user. The moment of My shown in FIG. 7 has a waveform of a user in the foot-lifting posture tilted to the right. Therefore, the steady-state moment P1 is generated as a moment shifted in the My⁻direction.

When the moment in the My⁻ direction detected by the detecting part 13 becomes larger from the steady-state moment P1, the posture estimating part 17 may determine that the right-foot swing leg period has started. When the moment in the My⁻ direction detected by the detecting part 13 returns to the steady-state moment P1 after start of the right-foot swing leg period, the posture estimating part 17 may determine that the right-foot swing leg period has ended.

An example of calculation of the left-foot swing leg period will be described. As in the example of calculation of the right-foot swing leg period, when the moment in the My⁺ direction detected by the detecting part 13 becomes larger from the steady-state moment P1, the posture estimating part 17 may determine that the left-foot swing leg period has started. When the moment in the My⁺ direction detected by the detecting part 13 returns to the steady-state moment P1 after start of the left-foot swing leg period, the posture estimating part 17 may determine that the left-foot swing leg period has ended.

The calculations of the right-foot swing leg period and the left-foot swing leg period are examples and are not limited thereto. For example, the right-foot swing leg period and the left-foot swing leg period during walking of the user may be calculated from the handle load in the Fz direction.

An example of calculation of the foot-lifting amount based on the handle load will be described.

The posture estimating part 17 calculates the foot-lifting amount of the right foot based on a speed v1 (hereinafter referred to as “first change speed v1”) at which the moment in the My⁻ direction changes in an initial stage ts1 of the right-foot swing leg period. When the first change speed v1 of the moment in the My⁻ direction is larger, the posture estimating part 17 determines that the right foot is more swiftly lifted and that the foot-lifting amount of the right foot is higher.

Specifically, an equation used for calculating the foot-lifting amount of the right foot may be “(the foot-lifting amount, of the right foot)=(the first change speed v1 of the moment in the My⁻ direction)×(a coefficient K)”, The coefficient K is set to a value suitable for each user. For example, since each user has an individual difference, the coefficient K may be a coefficient visually set by checking the foot-lifting posture of a user in advance.

The posture estimating part 17 calculates the foot-lifting amount of the left foot based on a speed v2 (hereinafter referred to as “second change speed v2”) at which the moment in the My⁺ direction changes in an initial stage ts2 of the left-foot swing leg period. When the second change speed v2 of the moment in the My⁺ direction is larger, the posture estimating part 17 determines that the left foot is more swiftly lifted and that the foot-lifting amount of the left foot is higher.

Specifically, an equation used for calculating the foot-lifting amount of the left foot may be “(the foot-lifting amount of the left foot)=(the second change speed v2 of the moment in the My⁺ direction)×(the coefficient K)”.

The calculation of the foot-lifting amount is an example and is not limited thereto. For example, a trajectory of foot lifting may be estimated based on a speed of change in the moment of My and the swing leg period. Specifically, an equation used for calculating the trajectory of foot lifting may be “(the trajectory of foot lifting)=(the speed of change in the moment of My)×(the swing leg period)”. The trajectory of foot-lifting is a trajectory of a foot position when the foot is lifted off the ground until being put onto the ground.

The posture estimating part 17 may estimate unsteadiness of the user based on fluctuation of the moment of My.

Returning to FIGS. 4 and 5, the posture estimating part 17 includes a gymnastic posture estimating part 25 estimating the gymnastic posture of the foot-lifting posture, and a walking posture estimating part 26 estimating the walking posture of the foot-lifting posture.

The gymnastic posture estimating part 25 estimates the gymnastic posture that is the foot-lifting posture when the user is performing the foot-lifting gymnastic exercise in a standing state, based on the handle load detected by the detecting part 13. The gymnastic posture estimating part 25 transmits information of the gymnastic posture to a gymnastic posture information database 27.

For example, the gymnastic posture includes at least one of a foot-lifting amount, a time of lifting of the foot (foot-lifting time), and a fluctuation when the user is performing the foot-lifting gymnastic exercises.

The walking posture estimating part 26 estimates the walking posture that is the foot-lifting posture when the user is walking, based on the handle load detected by the detecting part 13. The walking posture estimating part 26 transmits information of the walking posture to a walking posture information database 28.

For example, the walking posture includes at least one of a foot-lifting amount, a foot-lifting time, a fluctuation, a stride, a walking speed, and a walking pitch when the user is walking.

The stride, the walking speed, and the walking pitch can also be estimated based on the handle load detected by the detecting part 13. For example, the actuator control part 23 estimates a moving distance of the robot 1 from the rotation amounts of the rotating bodies 20, The actuator control part 23 transmits information of the rotation amounts of the rotating bodies 20 to the walking posture estimating part 26. The walking posture estimating part 26 may estimate the stride, the walking speed, and. the walking pitch based on the information of the rotation amounts of the rotating bodies 20 and the foot-lifting time estimated from the handle load.

In this description, the gymnastic posture information database 27 and the walking posture information database 28 may collectively be referred to as a posture information database 29.

In the first embodiment, the robot 1 includes the posture information database 29. The robot 1 may not include the posture information database 29. The posture information database 29 may be located outside the robot 1. For example, the posture information database 29 may be made up of a server etc. outside the robot 1. In this case, the robot 1 may access the posture information database 29 through wireless and/or wired communication means to download the posture information.

The training scenario generating part 18 corrects the training scenario based on the foot-lifting posture. Specifically, the training scenario generating part 18 receives the information of the foot-lifting posture from the posture information database 29 and corrects the training scenario based on the information of the foot-lifting posture.

The training scenario generating part 18 includes a gymnastic training scenario generating part 30 generating a gymnastic training scenario that is a training scenario in which the user performs the foot-lifting gymnastic exercise in a standing state and a walking training scenario generating part 31 generating a walking training scenario that is a training scenario in which the gait of the user during walking is changed.

The gymnastic training scenario generating part 30 corrects the gymnastic training scenario. Specifically, the gymnastic training scenario generating part 30 receives the information of the gymnastic posture and/or the walking posture from the posture information database 29 and corrects the gymnastic training scenario based on the information of the gymnastic posture and/or the walking posture.

For example, if the foot-lifting amount is small in the information of the gymnastic posture and/or the walking posture, the gymnastic training scenario generating part 30 may correct the gymnastic training scenario to increase the number of times of foot lifting. The presenting part 19 may present the foot-lifting instruction and the number of times of foot lifting to the user.

If the foot-lifting time is short in the information of the gymnastic posture and/or the walking posture, the gymnastic training scenario generating part 30 may correct the gymnastic training scenario to make the foot-lifting time longer. The presenting part 19 may present the foot-lifting instruction and the foot-lifting time to the user.

If the user is unsteady, i.e., if fluctuation is occurring, in the information of the gymnastic posture and/or the walking posture, the gymnastic training scenario generating part 30 may correct the gymnastic training scenario to correct the foot-lifting posture of the user. For example, the gymnastic training scenario generating part 30 may present an instruction for correcting the foot-lifting posture of a user while making intervals longer between instructions for foot-lifting given by the presenting part 19.

If the speed of foot lifting is slow in the information of the gymnastic posture and/or the walking posture, the gymnastic training scenario may be corrected to increase the speed of foot lifting. The presenting part 19 may present the foot-lifting instruction to the user. Specifically, intervals maybe made shorter between instructions for foot-lifting given by the presenting part 19.

If a difference exists in the foot-lifting amount, the foot-lifting time, and/or the speed between the left and right feet in the information of the gymnastic posture and/or the walking posture, the gymnastic training scenario generating part 30 may correct the gymnastic training scenario such that the muscle of the leg desired to be preferentially trained is used. For example, if the foot-lifting amount of the right foot is smaller than the foot-lifting amount of the left foot, the gymnastic training scenario generating part 30 may correct the scenario to make the number of times of foot lifting of the right foot larger than the left foot. If the foot-lifting time of the right foot is shorter than the foot-lifting time of the left foot, the gymnastic training scenario generating part 30 may correct the scenario to make the foot-lifting time of the right foot longer as compared to the left foot. If the foot-lifting speed of the right foot is slower than the foot lifting speed of the left foot, the gymnastic training scenario generating part 30 may correct the scenario to make the speed of lifting of the right foot faster than the left foot.

Additionally, the gymnastic training scenario generating part 30 may correct the gymnastic training scenario based on information of the stride, the walking speed, the walking pitch, and/or differences thereof between the left and right feet included in the information of the walking posture.

The walking training scenario generating part 31 corrects the walking training scenario. Specifically, the walking training scenario generating part 31 receives the information of the gymnastic posture and/or the walking posture from the posture information database 29 and corrects the walking training scenario based on the information of the gymnastic posture and/or the walking posture.

For example, if the foot-lifting amount, the foot-lifting time, and/or the lifting speed is small in the information of the gymnastic posture and/or the walking posture, the walking training scenario generating part 31 may correct the walking training scenario to reduce the movement speed of the robot 1 so that the gait of the user during walking is changed. Alternatively, the walking training scenario generating part 31 may correct the walking training scenario to complicate the walking route so that the gait of the user during walking is changed. Complicating the walking route includes, for example, increasing the number of corners in the route from a departure place to a destination.

If the user is unsteady, i.e., if fluctuation is occurring, in the information of the gymnastic posture and/or the walking posture, the walking training scenario generating part 31 may correct the walking training scenario to correct the foot-lifting posture of a user. For example, the walking training scenario generating part 31 may correct the walking training scenario to present an instruction for correcting the foot-lifting posture of a user by the presenting part 19 while correcting the walking route into a monotonous route.

If a difference exists in the foot-lifting amount, the foot-lifting time, and/or the foot-lifting speed between the left and right feet in the information of the gymnastic posture and/or the walking posture, the walking training scenario generating part 31 may correct the walking training scenario such that the muscle of the leg desired to be preferentially trained is used. For example, the walking training scenario generating part 31 may correct the walking training scenario to make the movement speed of the robot 1 slower in the period (swing leg period) during which the leg desired to be preferentially trained is lifted so that the muscle of the leg desired to be preferentially trained is used. Alternatively, the walking training scenario generating part 31 may correct the walking training scenario to change the walking route such that a turning motion is performed to the side opposite to the leg desired to be preferentially trained.

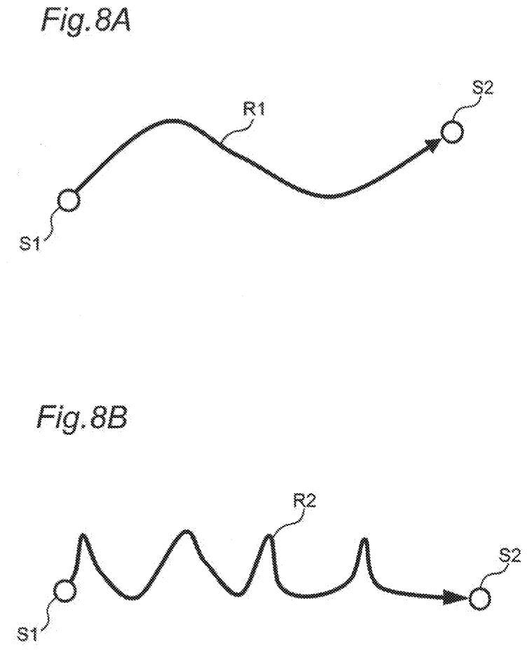

FIG. 8A is a diagram showing an example of the walking route. FIG. 8A shows, as an example, a first walking route R1 from a departure place S1 to a destination S2 set as a monotonous route. As shown in FIG. 8A, the first walking route R1 has a reduced number of corners. Additionally, in the first walking route R1, angles of the corners are gentle.

FIG. 8B is a diagram showing another example of the walking route. FIG. 8B shows, as an example, a second walking route R2 from the departure point S1 to the destination S2 set as a complicated route. As shown in FIG. 8B, the second walking route R2 has an increased number of comers. Additionally, in the second walking route R2, angles of corners turning to the right are sharper than angles of comers turning to the left. This causes the user walking on the second walking route R2 to lift the left foot for a longer time than the right foot so that the muscle of the left leg is used more than the right leg. As a result, the user can preferentially train the left leg over the right leg.

The correction of the gymnastic training scenario and the walking training scenario described above is an example, and the correction of the gymnastic training scenario and the walking training scenario is not limited thereto. The gymnastic training scenario generating part 30 and the walking training scenario generating part 31 may correct the gymnastic training scenario and the walking training scenario, respectively, based on the information of the stride, the walking speed, the walking pitch, and/or differences thereof between the left and right feet included in the information of the walking posture.

The training scenario generating part 18 generates an instruction to the user based on the generated or corrected training scenario. The instruction to the user based on the training scenario includes, for example, a foot-lifting instruction, a correction instruction for the foot-lifting posture, and/or a guiding instruction for the walking route. The presenting part 19 presents the instruction to the user through a voice, an image, and/or a video on the basis of the information of the instruction to the user based on the training scenario. As a result, the user can perform the foot-lifting exercise in accordance with the instruction presented on the presenting part 19.

The training scenario generated or corrected by the training scenario generating part 18 may be stored in the training scenario information database, for example. The training scenario information database may be included in the robot 1. Alternatively, the training scenario information database may be a server etc. disposed outside the robot 1. The training scenario generating part 18 may acquire training scenarios of past users from the training scenario information database.

The walking supporting part 15 may acquire the information of the walking training scenario from the training scenario information database and correct the movement speed and the movement direction of the robot 1 based on the information of the walking training scenario. For example, if the gait of the right foot is changed in the walking training scenario, the walking supporting part 15 may reduce the movement speed of the robot 1 when the right foot is lifted.

The walking supporting part 15 may acquire the information of the foot-lifting posture from the posture information database 29 and correct the movement speed and the movement direction of the robot 1 in accordance with the foot-lifting posture of the user.

### [Main Control of Walking Training Robot]

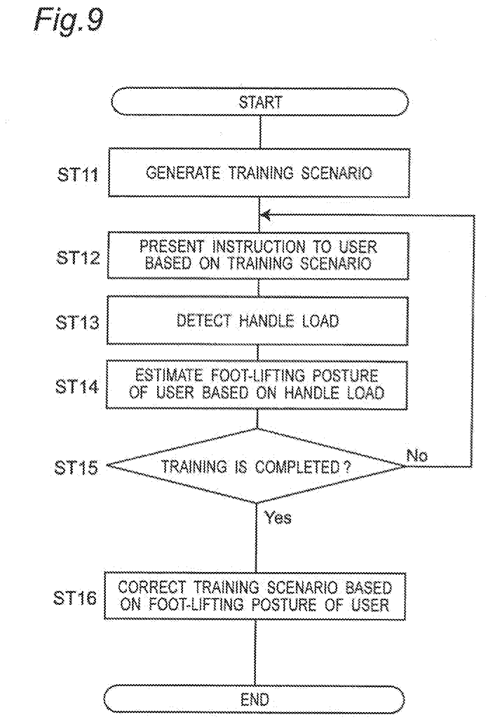

An example of the main control of the walking training robot 1 will be described. FIG. 9 shows an exemplary flowchart of the main control of the robot 1.

As shown in FIG. 9, at step ST11, the training scenario generating part 18 generates a training scenario. Specifically, the training scenario generating part 18 generates a training scenario causing a user to perform a foot-lifting exercise before the user starts training. For example, at step ST11, the training scenario generating part 18 causes the presenting part 19 to present an exercise menu and/or a question to the user. The training scenario generating part 18 may generate the training scenario based on the exercise menu selected by the user and/or a result of answer to the question. The training scenario generating part 18 generates an instruction to the user based on the generated training scenario. Information of the instruction to the user based on the training scenario is transmitted to and stored in the training scenario information database, for example.

At step ST12, the presenting part 19 presents an instruction to the user based on the training scenario generated at step ST11. For example, the presenting part 19 presents to the user a foot-lifting instruction, a correction instruction for the foot-lifting posture, and/or a guiding instruction for the walking route. For example, at step ST12, the presenting part 19 presents the instruction to the user through a voice, an image, and/or a video. The user performs the training, i.e., the foot-lifting exercise, in accordance with the instruction presented on the presenting part 19 while gripping the handle part 12. The presenting part 19 acquires information of the instruction to the user based on the training scenario from the training scenario information database.

At step ST13, the detecting part 13 detects the handle load. Specifically, while the user is performing the foot-lifting exercise in accordance with the instruction from the presenting part 19, the detecting part 13 detects the handle load applied to the handle part 12.

At step ST14, the posture estimating part 17 estimates the foot-lifting posture of the user based on the handle load detected at step ST13. In the first embodiment, the posture estimating part 17 estimates the foot-lifting posture based on the moment of My as described above. The posture estimating part 17 transmits the information of the estimated foot-lifting posture to the posture information database 29.

At step ST15, the training scenario generating part 18 determines whether the training of the user is completed. For example, the training scenario generating part 18 determines whether all the foot-lifting exercises included in the training scenario are completed.

If the training scenario generating part 18 determines that the training is completed at step ST15, the flow goes to step ST16. If the training scenario generating part 18 determines that the training is not completed, the flow returns to ST12.

At step ST16, the training scenario generating part 18 corrects the training scenario based on the foot-lifting posture of a user. Specifically, the training scenario generating part 18 acquires information of the foot-lifting posture from the posture information database 29. The training scenario generating part 18 corrects the training scenario based on the acquired information of the foot-lifting posture.

In this way, the robot 1 executes steps ST11 to ST16 to make a correction into the training scenario suitable for the user based on the training result. Therefore, the robot 1 can efficiently improve the physical ability of the user.

In the example described with the flowchart shown in FIG. 9, step ST16 of correcting the training scenario is executed after the training is completed; however, the present invention is not limited thereto. Step ST16 may be executed while the user is performing the training. In other words, the training scenario generating part 18 may correct the training scenario while the user is performing the training. As a result, the training scenario generating part 18 can correct the training scenario even during the training into a scenario in which the training can more efficiently be performed.

### [First Example of Control of Walking Training Robot]

A control for correcting the walking training scenario baaed on the gymnastic training result will be described as a first example of the control of the walking training robot 1. Specifically, description will be made of an example of the control for correcting the walking training scenario based on the gymnastic posture information acquired while the user is performing the gymnastic training.

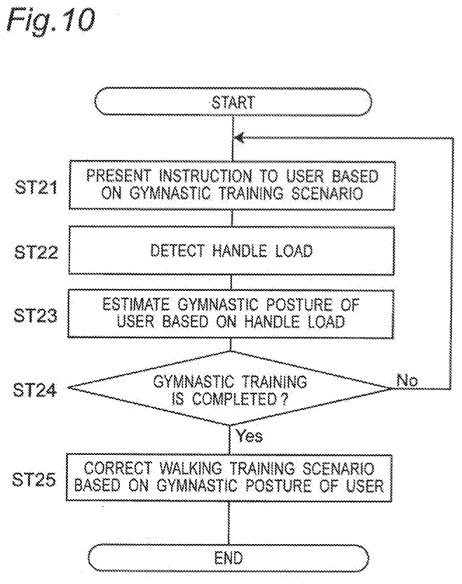

FIG. 10 shows an exemplary flowchart of the control for correcting the walking training scenario based on the gymnastic training result. As shown in FIG. 10, at step ST21, the presenting part 19 presents an instruction to the user based on the gymnastic training scenario. At step ST21, the gymnastic training scenario may be a predefined scenario, a scenario corrected based on the foot-lifting posture information past users, or a scenario selected from a plurality of scenarios including different foot-lifting exercises by the user depending on a preference. The presenting part 19 acquires a gymnastic training scenario from the training scenario information database.

As a result, the user performs a gymnastic training while griping the handle part 12 in accordance with the instruction presented on the presenting part 19. Specifically, the user performs the foot-lifting gymnastic exercise in accordance with the foot-lifting instruction presented by the presenting part 19 while gripping the handle part 12 in a standing state.

At step ST22, the detecting part 13 detects the handle load. Specifically, while the user is performing the gymnastic training in accordance with the instruction of the presenting part 19, the detecting part 13 detects the handle load applied to the handle part 12.

At step ST23, the gymnastic posture estimating part 25 estimates the gymnastic posture of the user based on the handle load detected at step ST22. As described above, the gymnastic posture estimating part 25 estimates the gymnastic posture such as the foot-lifting amount during the gymnastic training based on the moment of My. The gymnastic posture estimating part 25 transmits the information of the estimated gymnastic posture to the gymnastic posture information database 27.

At step ST24, the walking training scenario generating part 31 determines whether the gymnastic training of the user is completed. For example, the walking training scenario generating part 31 determines whether all the foot-lifting exercises included in the gymnastic training scenario are completed.

If the walking training scenario generating part 31 determines that the gymnastic training is completed at step ST24, the flow goes to step ST25. If the walking training scenario generating part 31 determines that the gymnastic training is not completed, the flow returns to ST21.

At step ST25, the walking training scenario generating part 31 corrects the walking training scenario based on the gymnastic posture of the user. Specifically, the walking training scenario generating part 31 acquires information of the gymnastic posture from the gymnastic information database 27. The walking training scenario generating part 31 corrects the walking training scenario based on the acquired information of the gymnastic posture.

In the first embodiment, the walking training scenario generating part 31 corrects the walking training scenario based on the information of the gymnastic posture that is at least one piece of information of the foot-lifting amount, the foot-lifting time, and the fluctuation. Specifically, the walking training scenario generating part 31 compares differences in the gymnastic postures of the left and right feet and corrects the walking training scenario based on a comparison result.

For example, if the foot lifting amount of the right foot is smaller than the left foot in the foot-lifting gymnastic exercise, the walking training scenario generating part 31 may correct the walking training scenario such that the muscle of the right leg is trained as compared to the left leg. The correction of the walking training scenario may be made by, for example, limiting the movement speed of the robot 1 while the right foot is lifted and/or changing the walking route such that the number of turning motions to the left becomes larger than the number of turning motions to the right.

In this way, the robot 1 executes steps ST21 to ST25 to correct the walking training scenario based on the gymnastic training result. Therefore, the robot 1 can create an optimum walking training scenario depending on a user. As a result, the robot 1 can efficiently improve the physical ability of the user. The corrected walking training scenario is stored in the training scenario information database.

### [Second Example of Control of Walking Training Robot]

A control for correcting the gymnastic training scenario based on the gymnastic training result will be described as a second example of the control of the walking training robot 1. Specifically, description will be made of an example of the control for correcting the gymnastic training scenario based on the gymnastic posture information acquired while the user is performing the gymnastic training will be described.

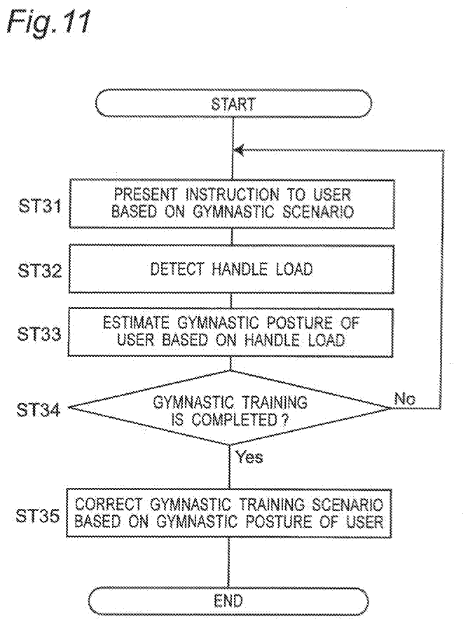

FIG. 11 shows an exemplary flowchart of the control for correcting the gymnastic training scenario based on the gymnastic training result. As shown in FIG. 11, at step ST31, the presenting part 19 presents an instruction to the user based on the gymnastic training scenario.

As a result, the user performs a gymnastic training while griping the handle part 12 in accordance with the instruction presented on the presenting part 19. Specifically, the user performs the foot-lifting gymnastic exercise in accordance with the foot-lifting instruction presented by the presenting part 19 while gripping the handle part 12 in a standing state.

At step ST32, the detecting part 13 detects the handle load. Specifically, while the user is performing the gymnastic training in accordance with the instruction of the presenting part 19, the detecting part 13 detects the handle load applied to the handle part 12.

At step ST33, the gymnastic posture estimating part 25 estimates the gymnastic posture of the user based on the handle load detected at step ST32. For the estimation of the gymnastic posture of the user, as described above, the gymnastic posture such as the foot-lifting amount is estimated based on the moment of My. The gymnastic posture estimating part 25 transmits the information of the estimated gymnastic posture to the gymnastic posture information database 27.

At step ST34, the gymnastic training scenario generating part 30 determines whether the gymnastic training of the user is completed. For example, the gymnastic training scenario generating part 30 determines whether all the foot-lifting exercises included in the gymnastic training scenario are completed.

If the gymnastic training scenario generating part 30 determines that, the gymnastic training is completed at step ST34. the flow goes to step ST35. If the gymnastic training scenario generating part 30 determines that the gymnastic training is not completed, the flow returns to ST31.

At step ST35, the gymnastic training scenario generating part 30 corrects the gymnastic training scenario based on the gymnastic posture of the user. Specifically, the gymnastic training scenario generating part 30 acquires information of the gymnastic posture from the gymnastic posture information database 27. The gymnastic training scenario generating part 30 makes a correction into the gymnastic training scenario suitable for the user based on the acquired information of the gymnastic posture.

In the first embodiment, the gymnastic training scenario generating part 30 corrects the gymnastic training scenario based on the information of the gymnastic posture that is at least one piece of information of the foot-lifting amount, the foot-lifting time, and the fluctuation. Specifically, the gymnastic training scenario generating part 30 compares differences in the gymnastic postures of the left and right feet and corrects the gymnastic training scenario based on a comparison result.

For example, if the foot-lifting amount of the right foot is smaller than the left foot in the foot-lifting gymnastic exercise, the gymnastic training scenario generating part 30 may correct the gymnastic training scenario such that the muscle of the right leg is trained as compared to the left leg. The correction of the gymnastic training scenario may be made by, for example, setting the number of times of foot lifting of the right foot larger than the left foot and/or setting the foot-lifting time of the right foot longer than the left foot.

In this manner, the robot 1 executes steps ST31 to ST35 to correct the gymnastic training scenario based on the gymnastic training result. As a result, an optimal gymnastic training scenario can be created depending on the physical ability of the user. The corrected gymnastic training scenario is stored in the training scenario information database.

In the examples described with the flowcharts shown in FIG. 10 and 11, the walking training scenario and the gymnastic training scenario are each separately corrected based on the gymnastic training result; however, the correction of the training scenarios is not limited thereto. For example, in the correction of the training scenarios, both the walking training scenario and the gymnastic training scenario may collectively be corrected based on the gymnastic training result.

### [Third Example of Control of Walking Training Robot]

A control for correcting the gymnastic training scenario and the walking training scenario based on the walking training result will be described as a third example of the control of the walking training robot 1. In the third example, the user performs a walking training based on the walking training scenario corrected in the first example. In the third example, the gymnastic training scenario and the walking training scenario are corrected based on the walking training result.

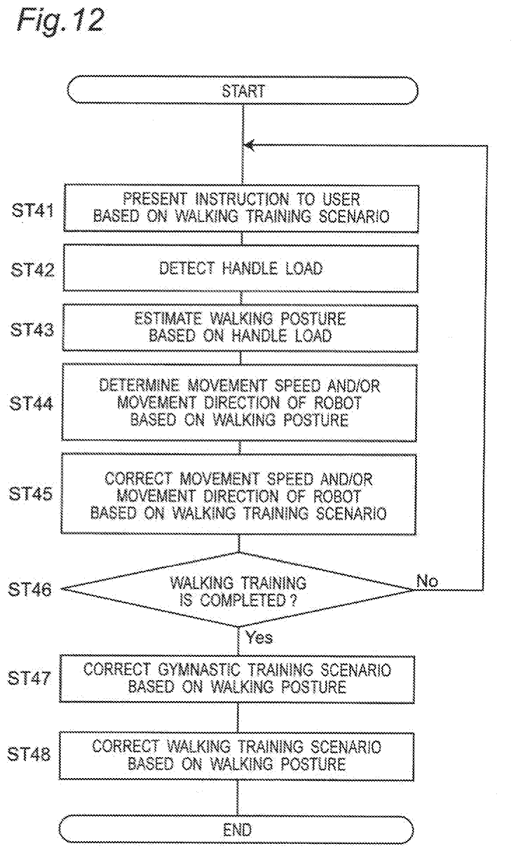

FIG. 12 shows an exemplary flowchart of the control for correcting the gymnastic training scenario and the walking training scenario based on the walking training result. As shown in FIG. 12, at step ST41, the presenting part 19 presents an instruction to the user based on the walking training scenario For example, the presenting part 19 presents an instruction to the user based on the walking training scenario acquired in the first example of the control of the robot 1 (see step ST25 of FIG. 10).

At step ST42, the detecting part 13 detects the handle load. Specifically, while the user is performing the walking training in accordance with the instruction of the presenting part 19, the detecting part 13 detects the handle load applied to the handle part 12.

At step ST43, the walking posture estimating part 26 estimates the walking posture of the user based on the handle load detected an step ST42. For the estimation of the walking posture of the user, as described above, the walking posture such as the foot-lifting amount is estimated based on the moment of My. The walking posture estimating part 26 transmits the information of the estimated walking posture to the walking posture information database 28.

At step ST44, the walking supporting part 15 determines the movement speed and/or the movement direction of the robot 1 based on the walking posture estimated at step ST43. Specifically, the walking supporting part 15 receives the information of the walking posture from the walking posture information database 28 and changes the movement speed and/or the movement direction of the robot 1 based on the received information of the walking posture. For example, the walking supporting part 15 reduces the movement speed of the robot 1 or changes the walking route to determine a load applied to the user.

At step ST45, the walking supporting part 15 corrects the movement speed and/or the movement direction of the robot 1 based on the walking training scenario. As a result, the training suitable for the user can be performed depending on the physical ability of the user.

At step ST46, the walking training scenario generating part 31 determines whether the walking training of the user is completed. For example, the walking training scenario generating part 31 determines whether all the foot-lifting exercises included in the walking training scenario are completed.

If the walking training scenario generating part 31 determines that the walking training is completed at step ST46, the flow goes to step ST47. If the walking training scenario generating part 31 determines that the walking training is not completed, the flow returns to ST41.

At step ST47, the gymnastic training scenario generating part 30 corrects the gymnastic training scenario based on the walking posture estimated at step ST43. Specifically, the gymnastic training scenario generating part 30 acquires information of the walking posture from the walking posture information database 28. The gymnastic training scenario generating part 30 makes a correction into the gymnastic training scenario suitable for the user based on the acquired information of the walking posture.

At step ST48, the walking training scenario generating part 31 corrects the walking training scenario based on the walking posture estimated at step ST43. Specifically, the walking training scenario generating part 31 acquires information of the walking posture from the walking posture information database 28. The walking training scenario generating part 31 makes a correction into the walking training scenario suitable for the user based on the acquired information of the walking posture.

In this way, the robot 1 executes steps ST41 to ST48 to correct the gymnastic training scenario and the walking training scenario based on the walking training result.

In the third example of the control of the robot 1 described in the first embodiment, the gymnastic training scenario and the walking training scenario are corrected based on the walking training result; however, the present invention is not limited thereto. In the third example of the control of the robot 1, the gymnastic training scenario or the walking training scenario may be corrected based on the walking training result. In other words, in the flowchart shown in FIG. 12, at least one of steps ST47 and ST48 may be executed.

In the third example described above, the user performs the walking training based on the walking training scenario corrected in the first example before the correction of the walking training scenario; however, the present invention is not limited thereto. The walking training scenario before the correction may be a predefined scenario, a scenario corrected based on the foot-lifting posture information of past users, or a scenario selected from a plurality of scenarios including different foot-lifting exercises by the user depending on a preference.

### [Fourth Example of Control of Walking Training Robot]

A control for correcting the gymnastic training scenario and the walking training scenario based on the gymnastic training result and the walking training result will be described as a fourth example of the control of the walking training robot 1. In the fourth example, the user performs a walking training based on the walking training scenario corrected in the first example. In the fourth example, the gymnastic training scenario and the walking training scenario are corrected based on the gymnastic training result acquired in the first example and the walking training result.

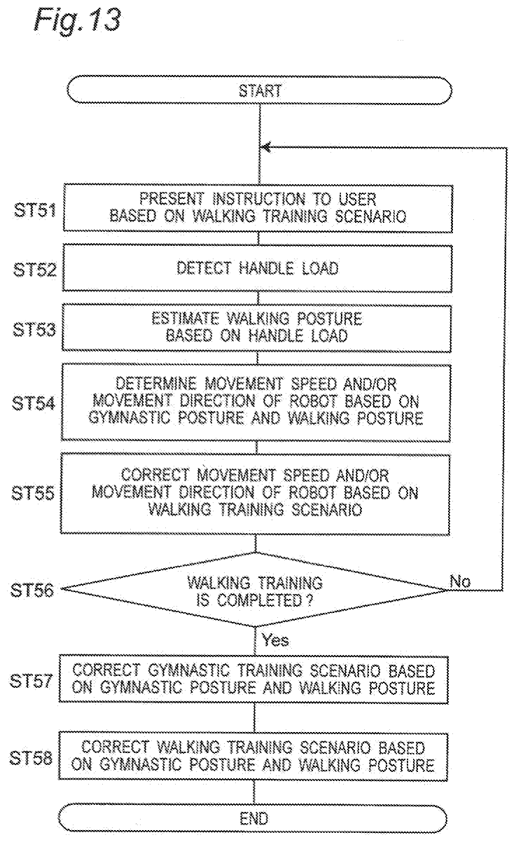

FIG. 13 shows an exemplary flowchart of the control for correcting the gymnastic training scenario and the walking training scenario based on the gymnastic training result and the walking training result. As shown in FIG. 13, steps ST51 to STS3 of the fourth example are the same as steps ST41 to 43 of the third example and therefore will not be described.

At step ST54, the walking supporting part 15 determines the movement speed and/or the movement direction of the robot 1 based on the gymnastic posture and the walking posture. Specifically, the walking supporting part 15 determines the movement speed and/or the movement direction of the robot 1 based on the information of the gymnastic posture acquired in the first example (see step ST23 of FIG. 10) and the information of the walking posture acquired at step ST53.

At step ST55, the walking supporting part 15 corrects the movement speed and/or the movement direction of the robot 1 based on the walking training scenario. As a result, the training suitable for the user can be performed depending on the physical ability of the user.

At step ST56, the walking training scenario generating part 31 determines whether the walking training of the user is completed. For example, the walking training scenario generating part 31 determines whether all the foot-lifting exercises included in the walking training scenario are completed.

If the walking training scenario generating part 31 determines that the walking training is completed at step ST56, the flow goes to step ST57, If the walking training scenario generating part 31 determines that the walking training is not completed, the flow returns to ST51.

At step ST57, the gymnastic training scenario generating part 30 corrects the gymnastic training scenario based on the gymnastic posture and the walking posture. Specifically, the gymnastic training scenario generating part 30 corrects the gymnastic training scenario based on the information of the gymnastic posture acquired in the first example (see step ST23 of FIG. 10) and the information of the walking posture acquired at step ST53.

At step ST58, the walking training scenario generating part 31 corrects the walking training scenario based on the gymnastic posture and the walking posture. Specifically, the gymnastic training scenario generating part 30 corrects the walking training scenario based on the information of the gymnastic posture acquired in the first example (see step ST23 of FIG. 10) and the information of the walking posture acquired at step ST53.

In this way, the robot 1 executes steps ST51 to 58 to correct the gymnastic training scenario and the walking training scenario based on the gymnastic training result and the walking training result. As a result, the gymnastic training scenario and the walking training scenario more suitable for the user can be created.

In the fourth example of the control of the robot 1 described in the first embodiment, the gymnastic training scenario and the walking training scenario are corrected based on the gymnastic training result and the walking training result; however, the present invention is not limited thereto. In the fourth example of the control of the robot 1, the gymnastic training scenario or the walking training scenario may be corrected based on the gymnastic training result and the walking training result. In other words, in the flowchart shown in FIG. 13, at least one of steps ST57 and ST58 may be executed.

In the fourth example described above, the user performs the walking training based on the walking training scenario corrected in the first example before the correction of the walking training scenario; however, the present invention is not limited thereto. The walking training scenario before the correction may be a predefined scenario, a scenario corrected based on the foot-lifting posture information of past users, or a scenario selected from a plurality of scenarios including different foot-lifting exercises by the user depending on a preference.

### [Effects]

The walking training robot 1 according to the first embodiment can produce the following effects.

The robot 1 can estimate the foot-lifting posture based on the handle load and correct the training scenario based on the estimated foot-lifting posture. This enables the robot 1 to create an optimum training scenario depending on the physical ability of the user. As a result, the robot 1 can efficiently improve the physical ability of the user.

The robot 1 uses the training scenario generating part 18 to correct the walking training scenario and/or the gymnastic training scenario based on the gymnastic posture during the gymnastic training. This enables the robot 1 to provide a more suitable walking training and/or gymnastic training depending on the physical ability of the user. As a result, the robot 1 can more efficiently improve the physical ability of the user.

The robot 1 uses the training scenario generating part 18 to correct the walking training scenario and/or the gymnastic training scenario based on the walking posture during the walking training. This enables the robot 1 to provide a more suitable walking training and/or gymnastic training to the user depending on the physical ability of the user. As a result, the robot 1 can more efficiently improve the physical ability of the user.

The robot 1 uses the training scenario generating part 18 to correct the walking training scenario and/or the gymnastic training scenario based on the gymnastic posture during the gymnastic training and the walking posture during the walking training. This enables the robot 1 to provide a more suitable walking training and/or gymnastic training to the user depending on the physical ability of the user. As a result, the robot 1 can more efficiently improve the physical ability of the user.

The robot 1 uses the walking supporting part 15 to correct the movement speed and the movement direction of the walking training robot 1 based on the walking training scenario. This enables the robot 1 to perform a suitable training depending on the physical ability of the user when the user is performing the walking training. As a result, the robot 1 can more efficiently improve the physical ability of the user.

In the first embodiment, the elements constituting the robot 1 may include, for example, a memory (not shown) storing a program causing these elements to function, and a processing circuit corresponding to a processor such as a CPU (Central Processing Unit), and the processor may execute the program and thereby function as these elements. Alternatively, the elements constituting the robot 1 may be constituted by using an integrated circuit causing these elements to function.

In the first embodiment, the operation of the walking training robot 1 has mainly been described; however, these operations can also be executed as a walking training method.

In the example described in the first embodiment, the detecting part 13 is a hexaxial force sensor; however, the present invention is not limited thereto. For example, the detecting part 13 may be a triaxial sensor or a strain sensor etc.

In the example described in the first embodiment, the posture estimating part 17 estimates the foot-lifting posture of the user based on the moment of My of the handle load detected by the detecting part 13; however, the present invention is not limited thereto. The posture estimating part 17 may estimate the foot-lifting posture of the user based on loads in the Fx, Fy, Fz directions and moments in the Mx, My, Mz directions, or rotation amounts and rotation directions of the rotating bodies 20, etc.

In the example described in the first embodiment, the rotation amounts of the two wheels (rotating bodies) 20 disposed on the rear side of the robot 1 are respectively set to control the forward mot ion, the backward motion, the right turning motion, the left turning motion etc.; however, the present invention is not limited thereto. For example, the rotation amounts of the wheels 20 may be controlled by a brake mechanism etc. to control the moving motion of the robot 1.

In the example described in the first embodiment, the presenting part 19 includes the speaker and/or the display; however, the present invention is not limited thereto. For example, the presenting part 19 may present an instruction to the user by presenting light to the surrounding environment by using LEDs etc. In an example, in walking training, light may be emitted in a desired direction in which a user is guided in the walking training.

In the example described above, the presenting part 19 presents an instruction to the user based on the training scenario; the present invention is not limited thereto. The presenting part 19 may present the information of the foot-lifting posture of the user. This enables the user to comprehend the his/her own foot-lifting posture and therefore can consciously perform the foot-lifting exercise. As a result, the physical ability of the user can more efficiently be improved.

In the example described in the first embodiment, the gymnastic training and the walking training include an exercise of lifting and lowering the feet; however, the present invention is not limited thereto. The gymnastic training and the walking training may include a twisting exercise, for example. The twisting exercise means a motion of twisting the body in left/right directions while the user is gripping the handle part 12. The twisting exercise may include, for example, an exercise in which the user twists the body in the right or left direction with both feet placed on the ground or an exercise in which the user twists the body in the right or left direction with one foot lifted. The twisting exercise may be performed by the user by him/herself without the robot 1 automatically rotating. Alternatively, the robot 1 may automatically rotate to guide the twisting exercise of the user. By performing the twisting exercise in this way, the flexibility of the user's legs can be enhanced.

Description will be made of the case that the user performs the twisting exercise by him/herself without the robot 1 automatically rotating. In this case, the user twists the body in the left/right directions while gripping the handle part 12 of the robot 1. In this case, the robot 1 is rotated by the twisting exercise of the user. A rotation amount of the twisting exercise may be calculated by the rotation amounts of the two rotating bodies 20 disposed on the rear side of the robot 1, for example. The training scenario generating part 18 may compare the rotation amount of the twisting exercise in the left direction with the rotation amount of the twisting exercise in the right direction arid correct the training scenario based on the comparison result.

For example, the walking training scenario generating part 31 of the training scenario generating part 18 may change the number of comers on the walking route based on the comparison result. In one example, when the rotation amount of the twisting exercise in the right direction is smaller as compared to the left direction, the walking training scenario generating part 31 may correct the walking route such that the number of comers turning to the right is increased as compared to the number of corners turning to the left.

Description will be made of the case that the robot 1 automatically rotates to guide the twisting exercise of the user. In this case, the walking supporting part 15 corrects the movement direction of the robot 1 when the user lifts one foot. For example, when the user lifts one foot, the walking supporting part 15 corrects the movement direction of the robot 1 in the direction in which the foot is lifted, and automatically rotates the robot 1. Subsequently, when one foot of the user goes down, the walking supporting part 15 puts the robot 1 back into the original movement direction and returns the robot 1 to the original position.

In one example, when the user lifts the right foot, the walking supporting part 15 corrects the movement direction of the robot 1 to the right and automatically rotates the robot 1 rightward. When the user lowers the right foot, the walking supporting part 15 corrects the movement direction of the robot 1 to the left and automatically rotates the robot 1 leftward. In this way, the robot 1 may automatically rotate to guide the twisting exercise of the user.

The walking supporting part 15 may estimate the direction in which the user lifts the foot based on the handle load detected by the detecting part 13. For example, when the downward lead (Fz⁻) is larger on the right-hand side of the handle part 12, the walking supporting part 15 may estimate that the foot is directed to the right. Additionally, the walking supporting part 15 may estimate the motion of the user lowering the foot based on the handle load.

The walking supporting part 15 may calculate the rotation amount of the twisting exercise based on a difference in stride between the right and left feet acquired during walking. The strides of the left and right feet may be calculated based on the time between peak values of the handle load and the rotation speeds of the rotating bodies 20. The estimation of the left and right feet may be performed based on a change in the handle load.

The gymnastic training and the walking training may include exercises such as one-foot heel lifting, one-foot toe lifting, both-feet heel lifting, both-feet toe lifting, and/or squat in addition to the twisting exercise. By performing these exercises, the physical ability of the user can more efficiently be improved. The posture of the user in these exercises can also be estimated from the handle load detected by the detecting part 13.

In the first embodiment, the robot 1 may include a camera, a distance sensor, etc. The posture estimating part 17 may estimate the foot-lifting posture based on information acquired by the camera, the distance sensor, etc.

In the example described in the first embodiment, the walking state estimating part 14 estimates the walking speed and the walking direction of the user based on the information of the handle load detected by the detecting part 13; however, the present invention is not limited thereto. In the example described above, the walking posture estimating part 26 estimates the walking speed and the walking direction of the user based on the information of the handle load detected by the detecting part 13; however, the present invention is not limited thereto.

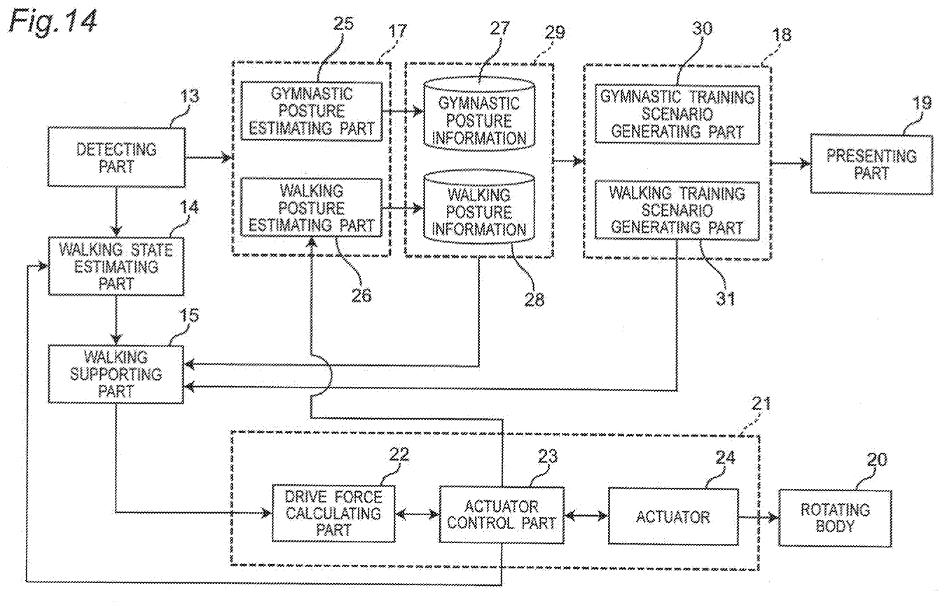

FIG. 14 is a control block diagram showing an example of a main control configuration of a modification of the robot 1. As shown in FIG. 14, the actuator control part 23 acquires information of the rotation amounts of the rotating bodies 20 from the actuator 24 and transmits the information of the rotation amounts and the rotation directions of the rotation bodies 20 to the walking state estimating part 14 and the posture estimating part 17.

The walking state estimating part 14 may receive the information of the rotation amounts and the rotation directions of the rotating bodies 20 from the actuator control part 23 and estimate the walking speed and the walking direction of the user based on the information of the rotation amounts and the rotation directions of the rotation bodies 20.

The walking posture estimating part 26 may receive information of the rotation amounts and the rotation directions of the rotating bodies 20 from the actuator control part 23 and estimate the foot-lifting posture when the user is walking, based on the information of the rotation amounts and the rotation directions of the rotation bodies 20.

In the example described in the first embodiment, the gymnastic training and the walking training are separately performed by using the robot 1; however, the present invention is not limited thereto. For example, the user may perform the walking training during walking and perform the gymnastic training while taking a break during walking. In other words, the gymnastic training may be performed when the user stops to take a break during the walking training.

For example, the robot 1 may estimate whether the robot 1 is moving or stopping based on the information of the rotation amounts of the rotating bodies 20 and switch between the walking training and the gymnastic training. Alternatively, the robot 1 may estimate whether the robot 1 is moving or stopping based on the information of the handle load and switch between the walking training and the gymnastic training. For the information of the handle load, for example, information of changes in Fy and My may be used.

Either the gymnastic exercise or the walking training may be performed with the robot 1.

In the example described in the first embodiment, the robot 1 includes the walking state estimating part 14; however, the present invention is not limited thereto. The walking state estimating part 14 is not an essential constituent element of the robot 1. When the robot 1 does not include the walking state estimating part 14, the walking supporting part 15 may determine the load of the robot 1 based on the handle load detected by the detecting part 13. For example, the walking supporting part 15 may determine the movement speed and the movement direction of the robot 1 based on the information of the handle load and the information of the rotation numbers of the rotating bodies. Even with such a configuration, the physical ability of the user can be improved.

In the the first embodiment, regarding the walking supporting part 15, the movement speed and the movement direction of the robot 1 have been described as an example of the load applied by the robot 1 to the walking exercise of the user; however, the present invention is not limited thereto. The load applied by the robot 1 may be any load at which an exercise can be performed for improving the physical ability of the user. For example, the load applied by the robot 1 may be a force required for pushing the robot 1 in the movement direction of the user. Specifically, the walking supporting part 15 may determine a force applying a load serving as a reaction force against the movement direction to a force of the user pressing the handle based on the handle load. As a result, the movement speed and the movement direction of the robot 1 may be determined. The load may serve as an exercise load requiring a force at the time of pushing the robot 1 and walking and may serve as a support; during walking. With such a configuration, the physical ability of the user can be improved.

### SECOND EMBODIMENT

A walking training robot according to a second embodiment of the present disclosure will be described. In the second embodiment, differences from the first embodiment will mainly be described. In the second embodiment, the same or equivalent constituent elements as the first embodiment are denoted by the same reference numerals. In the second embodiment, description overlapping with the first embodiment will not be made.

The second embodiment is different from the first embodiment in that a determining part is included for determining a complexity of a walking route that the user has walked.

### [Control Structure of Walking Training Robot]

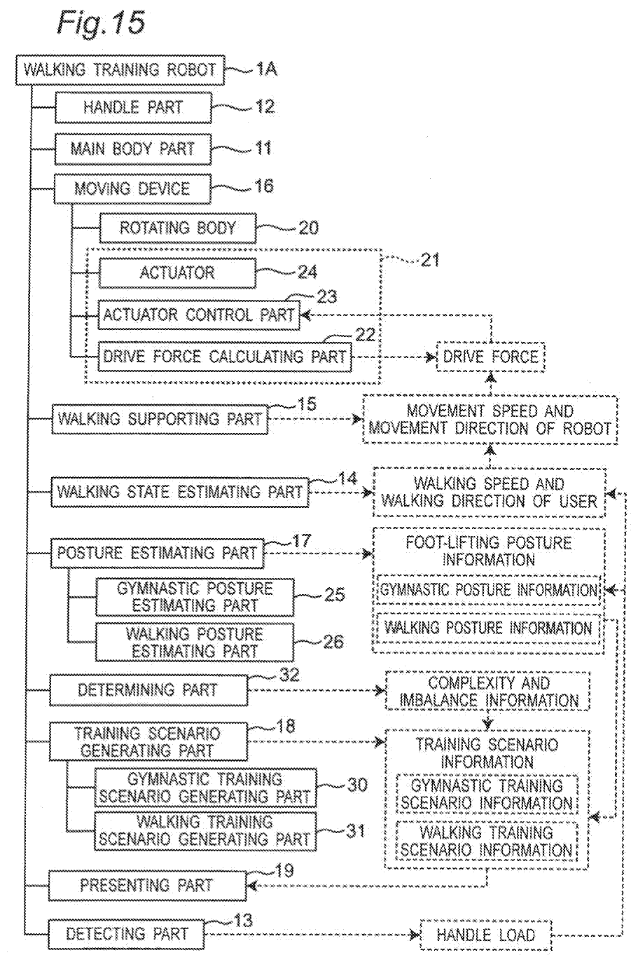

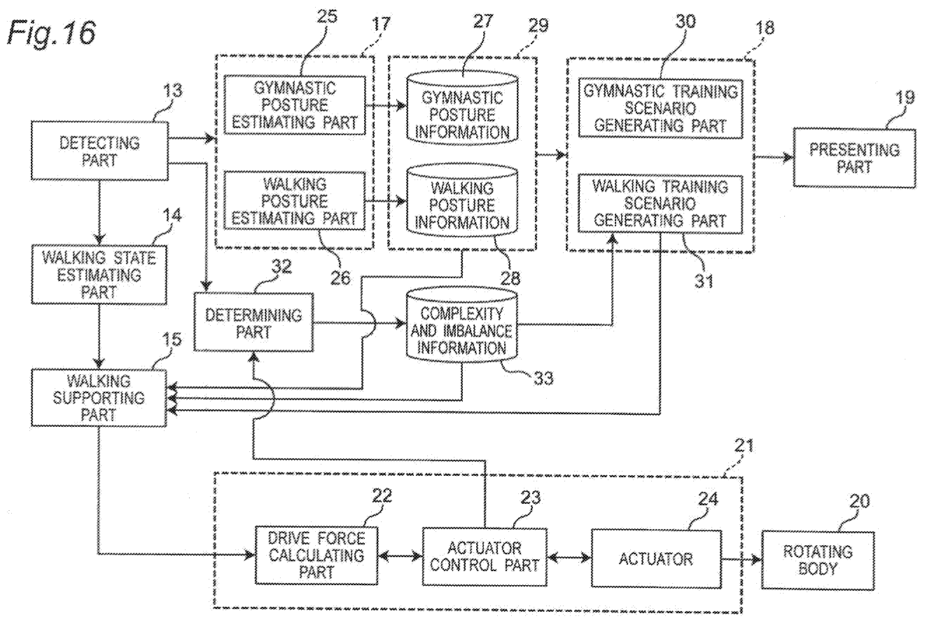

FIG. 15 is a control block diagram showing an example of a control configuration of a walking training robot 1A (hereinafter referred to as “robot 1A” according to the second embodiment. FIG. 16 is a control block diagram showing an example of a main control configuration of the robot 1A.

As shown in FIGS. 15 and 16, in the second embodiment, the robot 1A includes a determining part 32 determining a complexity of a walking route that the user has walked.

The determining part 32 determines the complexity of the walking route that the user has actually walked in the walking training. The determining part 32 determines the complexity of the walking route based on information such as the distance of the walking route, the number of corners, and the walking time, for example. The complexity of the walking route means a difficulty level for the user walking through the walking route.

In the second embodiment, the determining part 32 calculates a complexity degree of the walking route based on the rotation amounts and the rotation directions of the rotating bodies 20. The determining part 32 acquires the information of the rotation amounts and rotation directions of the rotating bodies 20 from the actuator control part 23.

The complexity degree is an evaluation value acquired by quantifying the complexity of the walking route. For example, when the distance of the walking route is longer and the number of corners is larger, the value of the complexity becomes larger.

For example, the determining part 32 may calculate the complexity degree by using as an equation for calculating the complexity degree “(the complexity degree)*(integrated value of rotation angle per certain distance)*(the number of reversals of rotation direction)”. The equation for calculating the complexity degree used by the determining part 32 is an example and the present invention is not limited to this calculation equation.

The determining part 32 may make the determination by classifying the complexity of the walking route into “high”, “medium”, and “low” based on the calculated complexity degree. For example, the determining part 32 may determine that the complexity is “high” when the value of the complexity degree is greater than a first threshold value, that the complexity is “low” when the value of the complexity degree is smaller than a second threshold value smaller than the first threshold value, and that the complexity is “medium” when the value of the complexity degree is between the first threshold value and the second threshold value.

For example, the first walking route R1 shown in FIG. 8A is determined by the determining part 32 as having a “low” complexity. The second walking route R2 shown in FIG. 8B is determined by the determining part 32 as having a “high” complexity.

The determining part 32 determines left-right imbalance of foot lifting of the user in the gymnastic training and the walking training. The determining part 32 determines the left-right imbalance of foot lifting of the user based on the handle load applied to the handle part 12. Specifically, the determining part 32 determines the left-right imbalance of foot lifting of the user based on the handle load detected by the detecting part 13.

In the second embodiment, for example, the determining part 32 determines the left-right imbalance of foot lifting of the user based on the moment of My at the time of lifting of the foot detected by the detecting part 13.

For example, the determining part 32 compares an amount of change in the moment of My when the foot is lifted between the left and right feet of the user and determines the left-right imbalance of foot lifting of the user. As a result of the comparison, if the amount of change in the moment of My at the time of lifting of the left foot is larger than the amount of change in the moment of My at the time of lifting of the right foot, the determining part 32 determines that the foot-lifting amount of the left foot is larger than the foot-lifting amount of the right foot. In other words, the determining part 32 determines that the left foot is lifted higher than the right foot.

The determining part 32 may compare an acceleration of the moment of My when the user lifts the foot between the left and right feet of the user to determine the left-right imbalance of foot lifting of the user. The determining part 32 may determine that the foot with a larger acceleration is more swiftly lifted.

The determining part 32 may estimate a rhythm of walking of the user from waveform information of the moment of My at the time of lifting of the feet and may acquire the foot-lifting time far each of the left and right feet of the user. The determining part 32 may calculate a stride of each of the left and right feet based on the left and right foot-lifting times of the user and the moving distance of the robot 1. The determining part 32 may determine the imbalance between the left and right feet based on the foot-lifting amount and the stride for the left and right feet of the user.

The determining part 32 transmits information of the complexity of the walking route and information of the left-right imbalance of foot lifting of the user to a complexity and imbalance information database 33. The complexity and imbalance information database 33 stores the information of the complexity of the walking route and the left-right imbalance of foot lifting of the user determined by the determining part 32.

The training scenario generating part 18 corrects the training scenario based on the complexity of the walking route and the left-right imbalance of foot lifting of the user determined by the determining part 32. In the second embodiment, the walking training scenario generating part 31 corrects the walking training scenario based on the gymnastic posture, the walking posture, the complexity of the walking route, and the left-right imbalance of foot lifting of the user.

The training scenario generating part 18 acquires the information of the gymnastic posture and the walking posture from the posture information database 29 and acquires the information of the complexity of the walking route and the left-right imbalance of foot lifting of the user from the complexity arid imbalance information database 33. The training scenario generating part 18 corrects the walking training scenario based on the acquired gymnastic posture, walking posture, complexity of the walking route, and left-right imbalance of foot lifting of the user.

For example, if the complexity of the walking route of the user is “high”, the walking training scenario generating part 31 may correct the walking training scenario to reduce a physical load applied to the user through control of the robot 1 for lowering the weight when the robot 1 is pushed. Alternatively, if the foot lifting of the user is imbalance between left and right, the walking training scenario generating part may correct the walking training scenario to include an instruction for correcting the foot-lifting posture to the user.

### [Example of Control of Walking Training Robot]

A control for correcting the walking training scenario based on a gymnastic training result, a walking training result, a complexity of a walking route, and a left-right imbalance will be described as an example of the control of the walking training robot 1A.

In the example of the control of the robot 1A, the user performs a walking training based on the walking training scenario corrected in the first example of the control of the first embodiment. For the gymnastic training result, the result acquired in the first example of the control of the first embodiment is used.

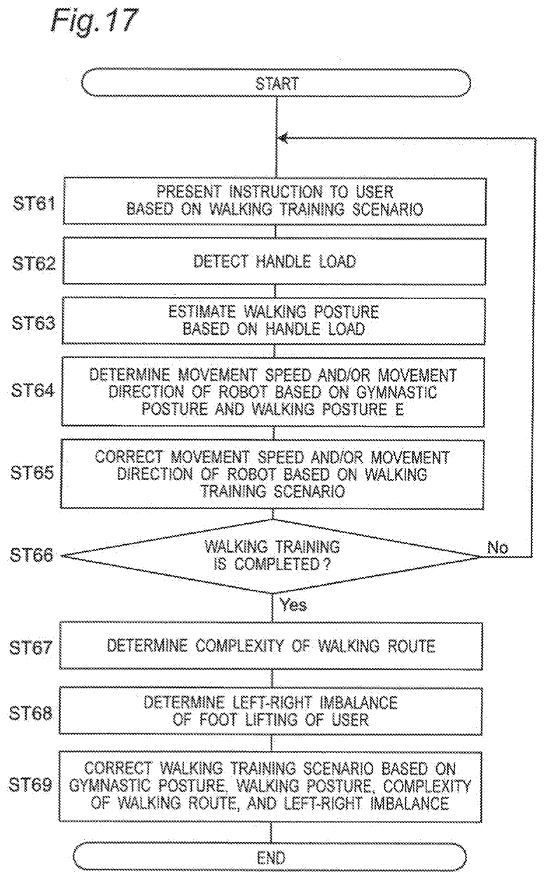

FIG. 17 shows an exemplary flowchart of the control for correcting the walking training scenario based on the gymnastic training result, the walking training result, the complexity of the walking route, and the left-right imbalance in the robot 1A. As shown in FIG. 17, steps ST61 to STS6 of the example of the control of the robot 1A are the same as steps ST51 to ST56 of the fourth example of control of the first embodiment and therefore will not be described. Description will be made of the example of the control after it is determined at step ST66 that the walking training is completed.

At step ST67, the determining part 32 determines the complexity of the walking route. Specifically, the determining part 32 calculates the complexity degree of the walking route that the user has actually walked, based on the rotation amounts and the rotation directions of the rotating bodies 20 in the walking training. The determining part 32 determines the complexity of the walking route based on a value of the calculated complexity degree. The determining part 32 transmits the information of the complexity of the walking route to the complexity and imbalance information database 33.

At step ST68, the determining part 32 determines the left-right imbalance of foot lifting of the user during walking training. Specifically, the determining part 32 determines the left-right imbalance of foot lifting of the user based on the moment of My at the time of lifting of the foot detected by the detecting part 13. The determining part 32 transmits the information of the left-right imbalance of foot lifting of the user to the complexity and imbalance information database 33.

At step ST69, the walking training scenario generating part 31 corrects the walking training scenario based on the gymnastic posture, the walking posture, the complexity of the walking route, and the left-right imbalance. Specifically, the walking training scenario generating part 31 corrects the walking training scenario based on the information of the gymnastic posture acquired in the first example of the control of the first embodiment (see step ST23 of FIG. 10), the information of the walking posture acquired at step ST63, the information of the complexity of the walking route acquired at step ST57, and the information of the left-right imbalance of foot lifting of the user acquired at step ST68.

In this way, the robot 1A executes steps ST61 to 69 to correct the walking training scenario based on the gymnastic training result, the walking training result, the complexity of the walking route, and the left-right imbalance. As a result, the walking training scenario suitable for the user can be created.

In the example described in the second embodiment, the walking training scenario is corrected based on the gymnastic training result, the walking training result, the complexity of the walking route, and the left-right imbalance; however, the present invention is not limited thereto.

For example, the walking training scenario generating part 31 may correct the walking training scenario based on at least one of the complexity of the walking route and the left-right imbalance, in other words, the flowchart shown in FIG. 17 may include at least one of steps ST67 and ST68. In this case, at step ST69, the walking training scenario generating part 31 may correct the walking training scenario based on the complexity of the walking route and/or the information of the left-right imbalance.

At step ST69, the walking training scenario generating part 31 may correct the walking training scenario without using the information of the gymnastic posture.

The flowchart shown in FIG. 17 may include a step of correcting the gymnastic training scenario based on the gymnastic training result, the walking training result, the complexity of the walking route, and the left-right imbalance.

### Effects

The walking training robot 1A according to the second embodiment can produce the following effects.

The walking training robot 1A can correct the training scenario based on the complexity of the walking route and the left-right imbalance of foot lifting of the user. Therefore, the training scenario can be corrected depending on the complexity of the walking route and the left-right imbalance of foot lifting in addition to the foot-lifting posture of the user. As a result, the physical ability of the user can more efficiently be improved.

Although the present disclosure has been described in some detail in terms of the embodiments, these contents of disclosure of the embodiments may obviously be changed in detail of configurations. Changes in combinations and orders of elements in the embodiments may be achieved without departing from the scope and the idea of the present disclosure.

### INDUSTRIAL APPLICABILITY

The present disclosure is applicable to a walking training robot improving a physical ability of a user.

### EXPLANATIONS OP LETTERS OR NUMERALS

1, 1A walking training robot
11 main body part
12 handle part
13 detecting part
14 walking state estimating part
15 walking supporting part
16 moving device
17 posture estimating part
18 training scenario generating part
19 presenting part
20 rotating body
21 driving part
22 drive force calculating part
23 actuator control part
24 actuator
25 gymnastic posture estimating part
26 walking posture estimating part
27 gymnastic posture information database
28 walking posture information database
29 posture information database
30 gymnastic training scenario generating part
31 walking training scenario generating part
32 determining part
33 complexity and imbalance information database

1. A walking training robot improving a physical ability of a user, comprising:
a main body part;
a handle part disposed on the main body part for being griped by the user;
a detecting part detecting a handle load applied to the handle part;
a walking supporting part determining a load applied by the walking training robot to a walking exercise of the user based on the handle load detected by the detecting part;
a moving device including a rotating body and controlling the rotating body to move the walking training robot based on the load of the walking training robot determined by the walking supporting part;
a posture estimating part estimating a foot-lifting posture of the user based on the handle load detected by the detecting part;
a training scenario generating part correcting a training scenario causing the user to perform a foot-lifting exercise, based on the foot-lifting posture; and
a presenting part presenting an instruction to the user based on the training scenario.

2. The walking training robot according to claim 1, wherein the load is a movement speed and a movement direction of the walking training robot.

3. The walking training robot according to claim 1, wherein the load is a force required for pushing the walking training robot in a movement direction of the user.

4. The walking training robot according to claim 1, wherein
the walking training robot includes a walking state estimating part estimating a walking speed and a walking direction of the user, and wherein
the walking supporting part determines the load of the walking training robot based on the walking speed and the walking direction of the user estimated by the walking state estimating part.

5. The walking training robot according to claim 1, wherein
the posture estimating part includes a gymnastic posture estimating part estimating a gymnastic posture that is the foot-lifting posture when the user is performing a foot-lifting gymnastic exercise in a standing state, based on the handle load detected by the detecting part, wherein
the training scenario generating part includes a walking training scenario generating part generating a walking training scenario that is the training scenario in which a gait of the user during walking is changed, and wherein the walking training scenario generating part corrects the walking training scenario based on the gymnastic posture.

6. The walking training robot according to claim 5, wherein
the training scenario generating part includes a gymnastic training scenario generating part generating a gymnastic training scenario that is the training scenario in which the user performs the foot-lifting gymnastic exercise in a standing state, and wherein
the gymnastic training scenario generating part corrects the gymnastic training scenario based on the gymnastic posture.

7. The walking training robot according to claim 5, wherein the walking supporting part corrects the load of the walking training robot based on the walking training scenario.

8. The walking training robot according to claim 5, wherein
the gymnastic posture estimating part estimates the gymnastic posture based on an axial moment around an axis extending in a front-rear direction of the walking training robot, and wherein
the gymnastic posture includes at least one of a foot-lifting amount, a time of lifting of a foot, and a fluctuation when the user is performing the foot-lifting gymnastic exercise.

9. The walking training robot according to claim 5, wherein the walking training scenario includes at least one of a guidance through a walking route from a current location to a destination of the user while the user is walking and a foot-lifting instruction.

10. The walking training robot according to claim 1, wherein
the posture estimating part includes a walking posture estimating part estimating a walking posture that is the foot-lifting posture when the user is walking, based on the handle load detected by the detecting part, wherein
the training scenario generating part includes a gymnastic training scenario generating part generating a gymnastic training scenario that is the training scenario in which the user performs the foot-lifting gymnastic exercise in a standing state, and wherein
the gymnastic training scenario generating part corrects the gymnastic training scenario based on the walking posture.

11. The walking training robot according to claim 10, wherein
the training scenario generating part includes a walking training scenario generating part generating a walking training scenario that is the training scenario in which a gait of the user during walking is changed, and wherein
the walking training scenario generating part corrects the walking training scenario based on the walking posture.

12. The walking training robot according to claim 11, wherein the walking supporting part corrects a movement speed and a movement direction of the walking training robot based on the walking training scenario.

13. The walking training robot according to claim 10, wherein
the walking posture estimating part estimates the walking posture based on an axial moment around an axis extending in a front-rear direction of the walking training robot, and wherein
the walking posture includes at least one of a foot-lifting amount, a time of lifting of a foot, a fluctuation, a stride, a walking speed, and a walking pitch when the user is walking.

14. The walking training robot according to claim 10, wherein
the gymnastic training scenario includes at least one of a foot-lifting amount and the number of times of foot lifting when the user performs a foot-lifting gymnastic exercise.

15. The walking training robot according to claim 1, wherein
the posture estimating part includes
a gymnastic posture estimating part estimating a gymnastic posture that is the foot-lifting posture when the user is performing a foot-lifting gymnastic exercise in a standing state, based on the handle load detected by the detecting part, and
a walking posture estimating part estimating a walking posture that is the foot-lifting posture when the user is walking, based on the handle load detected by the detecting part, wherein
the training scenario generating part includes a walking training scenario generating part generating a walking training scenario that is the training scenario in which a gait of the user during walking is changed, and wherein
the walking training scenario generating part corrects the walking training scenario based on the gymnastic posture and the walking posture.

16. The walking training robot according to claim 1, wherein
the posture estimating part includes
a gymnastic posture estimating part estimating a gymnastic posture that is the foot-lifting posture when the user is performing a foot-lifting gymnastic exercise in a standing state, based on the handle load detected by the detecting part, and
a walking posture estimating part estimating a walking posture that is the foot-lifting posture when the user is walking, based on the handle load detected by the detecting part, wherein
the training scenario generating part includes a gymnastic training scenario generating part generating a gymnastic training scenario that is the training scenario in which the user performs the foot-lifting gymnastic exercise in a standing state, and wherein
the gymnastic training scenario generating part corrects the gymnastic training scenario based on the gymnastic posture and the walking posture.

17. The walking training robot according to claim 1, further comprising a determining part determining a complexity of a walking route that the user has walked, based on a rotation amount and a rotation direction of the rotating body, wherein
the training scenario generating part corrects the training scenario based on the complexity of the walking route.

18. The walking training robot according to claim 17, wherein
the determining part further determines a left-right imbalance of foot lifting of the user based on the handle load detected by the detecting part, and wherein
the training scenario generating part corrects the training scenario based on the left-right imbalance of foot lifting.

19. The walking training robot according to claim 1, wherein the presenting part presents an instruction to the user based on the training scenario through light in a surrounding environment.

20. The walking training robot according to claim wherein the presenting part presents information of the foot-lifting posture of the user.
